(19) United States
(12) Patent Application Publication
(10) Pub. No.: US 2009/0303547 A1
(43) Pub. Date: Dec. 10, 2009

(54) DOCUMENT MANAGEMENT SYSTEM AND INFORMATION PROCESSING METHOD FOR THE DOCUMENT MANAGEMENT SYSTEM

(75) Inventor: Shukei Kurihara, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/480,431

(22) Filed: Jun. 8, 2009

(30) Foreign Application Priority Data
Jun. 10, 2008 (JP) 2008-151751

(51) Int. Cl. G06K 15/02; G06F 3/12

(52) U.S. Cl. 358/3.28; 358/1.15

(57) ABSTRACT

According to an instruction issued by a user for printing document information via a web browser of a client PC, a main control unit of an information processing apparatus included in a document management system issues an instruction to a document attribute/user attribute comparison unit for comparing a user attribute, which is stored in a user information storage unit, of the user who has instructed printing of the document information, and history information of the user attribute corresponding to print setting information associated with the document information, which is stored in the document information storage unit, whose printing has been instructed. Then, the main control unit determines print setting information to be used for printing the document information to be printed from among the print setting information stored on the document information storage unit according to a result of the comparison.

### BACKGROUND OF THE INVENTION

1. Field of the Invention

The present invention relates to a method and a system configured to manage a document. In particular, the present invention relates to a method for controlling a document management system configured to print a document managed therein after automatically setting print setting information, which is acquired and determined based on a user attribute and a document attribute, on the document.

2. Description of the Related Art

In a business office, a new employee and an employee who has newly become a member of a specific division by personnel changes may not be well informed about the business environment of the office. That is, such a new employee or a division new member may not know which printer is available or which print setting is appropriate for printing a document for a meeting, for example. Accordingly, such a new employee or a division new member may print a document on an inappropriate printer or with an inappropriate print setting.

In this regard, an existing division member may inform such a new employee or a division new member of the business environment. Alternatively, existing division members may produce a manual describing the local business environment. In order to avoid such a troublesome work, a method for flexibly establishing and arranging an office environment is expected.

Japanese Patent Application Laid-Open No. 2006-228066 discusses a system in which in printing a document that has already been printed at least once, the print setting used in the previous printing is recorded on the printer. In this system, the recorded print setting is utilized in reprinting the document.

However, in the above-described system discussed in Japanese Patent Application Laid-Open No. 2006-228066, since it is necessary to record the print setting (print history), the print setting cannot be used for printing a document that has never been printed. That is, in printing a document that has never been printed, it is necessary for a user to set all desired print setting on the document.

### SUMMARY OF THE INVENTION

The present invention is directed to a method for automatically determining a correlated print setting according to a user attribute and a document attribute in printing a document managed in a document management system.

According to an aspect of the present invention, a document management system configured to execute operations including managing document information, generating display data for displaying a content of the document information, and printing the document information according to an instruction issued by a user via a web browser of a client apparatus configured to execute display according to the generated display data includes a user attribute storage unit configured to store a user attribute of the user, a first history storage unit configured, when the document information managed in the document management system is printed, to store identification information for identifying the document information and print setting information used in printing the document information in association with each other, a second history storage unit configured, when the document information managed in the document management system is printed, to store the print setting information used in printing the document information and the user attribute of the user who has instructed the printing of the document information with the print setting information in association with each other, a user attribute comparison unit configured, when the user issues an instruction for printing the document information via the web browser of the client apparatus, to identify the print setting information stored on the first history storage unit in association with the identification information for identifying the document information whose printing has been instructed, identify the user attribute stored on the second history storage unit in association with the identified print setting information, and compare the identified user attribute with the user attribute of the user who has instructed the printing of the document information, which is stored in the user attribute storage unit, and a determination unit configured to determine print setting information to be used in printing the document information whose printing has been instructed by the user from among the print setting information stored on the second history storage unit according to a result of the comparison by the user attribute comparison unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features and aspects of the invention and, together with the description, serve to describe principles of the invention.

FIG. 1 illustrates an exemplary configuration of a document management system according to an exemplary embodiment of the present invention.

FIG. 2 is a block diagram illustrating an exemplary hardware configuration of each personal computer (PC) constituting the document management system according to an exemplary embodiment of the present invention.

FIG. 3 illustrates an exemplary software configuration of the document management system according to an exemplary embodiment of the present invention.

FIG. 4 is a schematic diagram illustrating print processing executed in the document management system according to an exemplary embodiment of the present invention.

FIG. 5 illustrates an example of a document list screen displayed on a display illustrated in FIG. 2 as a web user interface (UI) according to an exemplary embodiment of the present invention.

FIG. 6 illustrates an example of user information that is registered on a user management service server PC according to an exemplary embodiment of the present invention.

FIG. 7 illustrates an example of a document display screen displayed on the display illustrated in FIG. 2 as a web UI according to an exemplary embodiment of the present invention.

FIG. 8 illustrates an example of print history information, which is managed on a document information storage unit illustrated in FIG. 3 according to an exemplary embodiment of the present invention.

FIG. 9 illustrates an example of a detailed print setting recorded on the document information storage unit according to an exemplary embodiment of the present invention.

FIG. 10 is a flow chart illustrating a series of exemplary print processing executed by a web application server PC according to an exemplary embodiment of the present invention.

FIG. 11 is a flow chart illustrating exemplary print setting acquisition processing (step S1109 in FIG. 10) according to a first exemplary embodiment of the present invention.

FIG. 12 illustrates an example of the frequency of use of the print setting extracted from a print history stored on a document information storage unit illustrated in FIG. 3 in step S101 in FIG. 11.

FIG. 13 is a flow chart illustrating exemplary processing for determining user correlation degree (step S105 in FIG. 11) according to the first exemplary embodiment of the present invention.

FIG. 14 illustrates an example of a user attribute extracted in step S402 in FIG. 13.

FIG. 15 illustrates an example of the distribution of document attributes included in print history information managed on the document information storage unit illustrated in FIG. 3.

FIG. 16 illustrates an example of document information managed on the document information storage unit illustrated in FIG. 3.

FIG. 17 is a flow chart illustrating exemplary print setting acquisition processing (step S1109 in FIG. 10) according to a second exemplary embodiment of the present invention.

FIG. 18 is a flow chart illustrating exemplary print setting acquisition processing (step S1109 in FIG. 10) according to a third exemplary embodiment of the present invention.

FIG. 19 is a table illustrating the frequency of use of the print setting extracted, in step S301 in FIG. 18, from a print history stored on the document information storage unit that is illustrated in FIG. 3.

FIG. 20 illustrates an example of the distribution of the user attribute extracted from the print history for each printing apparatus.

FIG. 21 illustrates an example of a memory map of a storage medium (recording medium) storing various data processing programs that can be read by an information processing apparatus that is included in the document management system according to an exemplary embodiment of the present invention.

### DETAILED DESCRIPTION OF THE EMBODIMENTS

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

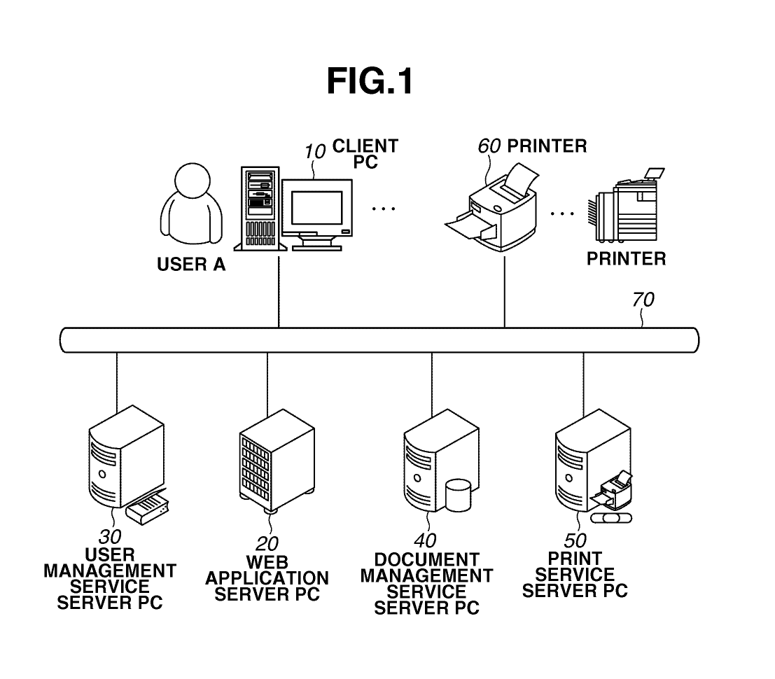

FIG. 1 illustrates an exemplary configuration of a document management system according to an exemplary embodiment of the present invention.

The document management system according to the present exemplary embodiment includes a client PC 10, a web application server PC 20, a user management service server PC 30, a document management service server PC 40, a print service server PC 50 and a printer 60, which are in communication with one another via a network 70.

A user A can access the document management system according to the present exemplary embodiment via a web browser operating on the client PC 10. The web browser is previously installed on the client PC 10. Furthermore, in usual cases, a plurality of client PC s 10 is connected to the network 70.

The web application server PC 20 provides a web application of the document management system. The user management service server PC 30 manages the information about a user who accesses (logs into) the document management system according to the present exemplary embodiment. The document management service server PC 40 includes a function for storing and managing documents.

The print service server PC 50 generates print data and transmits the generated print data to the printer 60. The printer 60 prints the received print data. A printer or a multifunction peripheral (MFP) can be used as the printer 60. A plurality of different types of printers can be mixedly connected to the network 70 at the same time. The network 70 can include a plurality of networks connected via a router.

In the present exemplary embodiment, the web application server PC 20, the user management service server PC 30, the document management service server PC 40, and the print service server PC 50 are disposed separately on the network 70. However, each function of each of the web application server PC 20, the user management service server PC 30, the document management service server PC 40, and the print service server PC 50 can be implemented on one PC at the same time.

Furthermore, in the present exemplary embodiment, the user A operates the client PC 10 to access the document management system. However, the user A can access the document management system via either one of or all of the web application server PC 20, the user management service server PC 30, the document management service server PC 40, and the print service server PC 50.

Furthermore, in the document management system according to the present exemplary embodiment, the user A accesses the document management system via the web browser.

However, the user A may access the document management system by operating a dedicated client application (not illustrated) provided on the client PC 10. In this case, the document management service server PC 40, instead of the web application server PC 20, can communicate with the dedicated client application.

In any configuration of the client PC 10, it is not necessary to install an application program for processing a document stored and managed in the document management system or a printer driver for the printer 60 on the client PC 10. The client PC 10 can correct, edit, or print the document stored and managed in the document management system by accessing the document management system via the web browser or the dedicated client application.

That is, the document management system manages document information and generates display data for displaying the content of the document information. Furthermore, the document management system executes processing on the document information according to a user instruction issued via the web browser of a client apparatus that executes the display based on the generated display data.

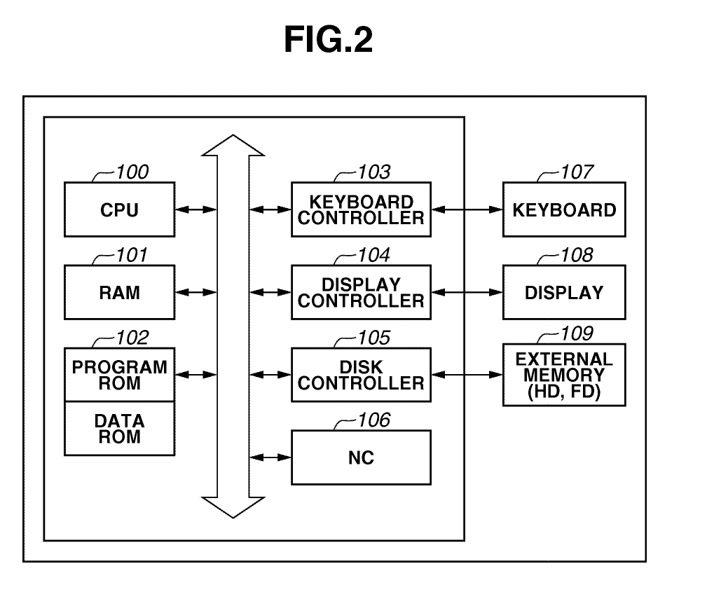

FIG. 2 is a block diagram illustrating an exemplary hardware configuration of each of the PCs 10 through 50 constituting the document management system according to the present exemplary embodiment.

The hardware configuration illustrated in FIG. 2 is similar to that of a general-purpose information processing apparatus. Each PC according to the present exemplary embodiment can have a hardware configuration of a general-purpose information processing apparatus.

Referring to FIG. 2, a central processing unit (CPU) 100 executes various programs (e.g., an operating system (OS) and an application) stored on a read-only memory (ROM) 102 or loaded from an external memory 109 (e.g., a hard disk) on a random access memory (RAM) 101.

The RAM 101 functions as a main memory and a work area for the CPU 100. The keyboard controller 103 controls a key input via a keyboard 107 and a pointing device (not illustrated).

A display controller 104 controls the display on various displays 108. A disk controller 105 controls data access to the external memory 109 such as a hard disk (HD) or a flexible disk (FD), which stores various data.

A network controller (NC) 106 is connected to the network 70. The NC 106 executes processing for controlling a communication with another apparatus connected to the network 70.

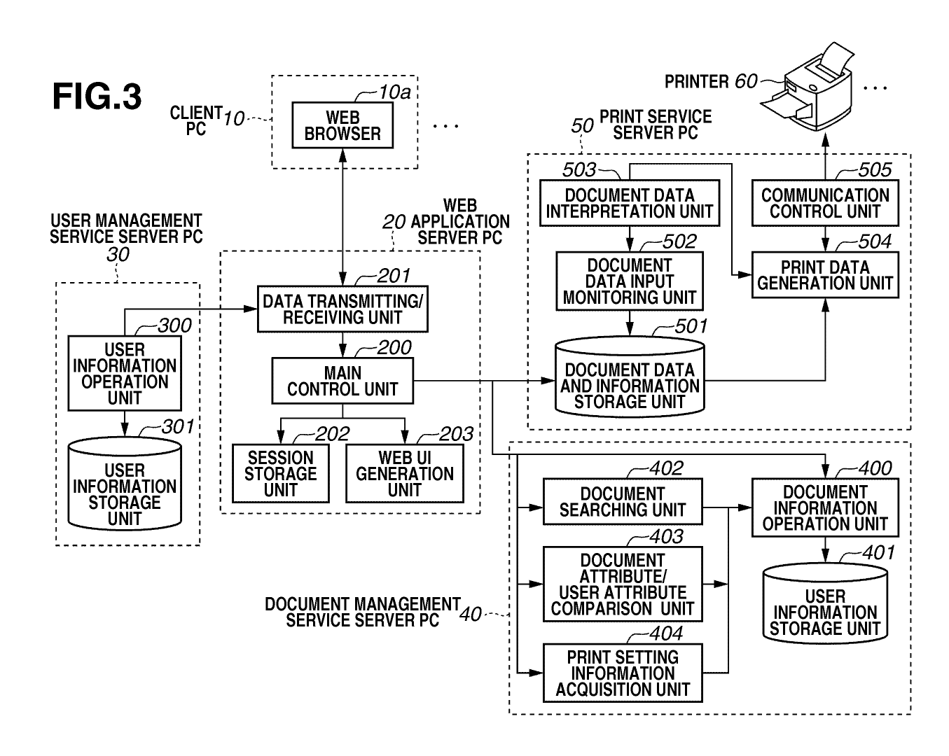

FIG. 3 illustrates an exemplary software configuration of the document management system according to the present exemplary embodiment. Components of the document management system that are the same as those illustrated in FIG. 1 are provided with the same reference numerals and symbols.

Now, an exemplary software configuration of each of the client PC 10, the web application server PC 20, the user management service server PC 30, the document management service server 40, and the print service server PC 50, illustrated in FIG. 1, according to the present exemplary embodiment will be described in detail below with reference to FIG. 3.

Referring to FIG. 3, the web application server PC 20 includes a main control unit 200. The main control unit 200 controls the entire operation of the document management system according to the present exemplary embodiment. Furthermore, the main control unit 200 issues instructions to the following units and executes management thereof.

A data transmitting and receiving unit 201 receives a command (request) issued by a user via a web browser 10a of the client PC 10 and transmits the received request to the main control unit 200. Furthermore, the data transmitting and receiving unit 201 transmits a result in response to the instruction by the main control unit 200 to the client PC 10.

A session storage unit 202 generates session information. More specifically, after the user has accessed the document management system via the web browser 10a of the client PC 10, the session storage unit 202 generates session information, which indicates the access has been performed by the same user. In addition, the session storage unit 202 associates various information to be used repeatedly during a time period from the start of a session to the discontinuation of the access to the document management system by the user (logout of the user) or the discontinuation of the session due to automatic timeout with the session information.

A web user interface (web UI) generation unit 203 generates a web UI (by using Hypertext Markup Language (HTML)) according to the current status of the document management system in response to the instruction from the main control unit 200.

The language used in generating a web UI with the web UI generation unit 203 is not limited to HTML. That is, a script language such as Java® Script or other structuring language can be used for generating a web UI by the web UI generation unit 203.

A user information operation unit 300 of the user management service server PC 30 illustrated in FIG. 3 extracts a user who can access the document management system, and a user attribute of the user according to an instruction from the main control unit 200. The information about the user is stored in a user information storage unit 301. In addition, the user information operation unit 300 edits an attribute of a user (user attribute), which is also stored in the user information storage unit 301, according to an instruction from the main control unit 200.

The method of managing a user is not limited to the method unique to the document management system. That is, a publicly known method, such as Active Directory or Lightweight Directory Access Protocol (LDAP) can be used in cooperation with the user information operation unit 300. That is, the user information storage unit 301 can function as a user attribute storage unit that stores a user attribute only. A document information operation unit 400 of the document management service server PC 40 registers, stores, extracts, and edits an entity and an attribute of a document stored in the document information storage unit 401 according to an instruction from the main control unit 200.

The document information storage unit 401 also functions as a print history storage unit that stores not only the document information (the entity of the document) but also the print setting information. The print setting information is acquired when printing the document information as a print history.

A document searching unit 402 determines a method for searching for a document according to an instruction from the main control unit 200. In addition, the document searching unit 402 acquires a result of the search from the document information storage unit 401 via the document information operation unit 400.

A document attribute/user attribute comparison unit 403 compares a document attribute and a user attribute according to an instruction from the main control unit 200. Furthermore, the document attribute/user attribute comparison unit 403 determines the degree of correlation between the attribute included in the print setting information stored in the document information storage unit 401 and the document attribute via the document information operation unit 400 when needed.

A print setting information acquisition unit 404 acquires information about the frequency of use of print setting information according to an instruction from the main control unit 200. In addition, the print setting information acquisition unit 404 acquires print setting information designated as the print setting information to be used according to the information about the degree of correlation between the document attribute and the user attribute according to an instruction from the main control unit 200.

A document data and information storage unit 501 of the print service server PC 50 stores document data and print setting information according to an instruction from the main control unit 200.

A document data input monitoring unit 502 monitors the document data stored in the document data and information storage unit 501. More specifically, when document data is stored in the document data and information storage unit 501, the document data input monitoring unit 502 reads the document data and transmits the document data to a document data interpretation unit 503.

The document data interpretation unit 503 interprets the received document data and transmits the document data to the print data generation unit 504. The print data generation unit 504 generates print data based on the received document data. Then, the print data generation unit 504 transmits the generated print data to a communication control unit 505. The communication control unit 505 transmits the received print data to the printer 60. Then, the print data is printed by the printer 60.

As described above, in the document management system according to the present exemplary embodiment, the client PC 10 can display and edit document information by logging into (accessing) the document management system via the web application server PC 20. That is, the client PC 10 displays and edits document information via the web application server PC 20. Accordingly, the document information (document information file) itself is not downloaded into a local environment of the client PC 10.

Furthermore, an available print service server PC 50 is registered on the web application server PC 20. When the user inputs a print instruction, the web application server PC 20 transmits document data and a print setting to the print service server PC 50.

A printer driver and an application that can edit the document data are installed on the print service server PC 50. The print service server PC 50 uses the received document data and an appropriate application and prints the data with a designated print setting. The print setting set on the web application server PC 20 is stored in the document information storage unit 401 of the document management service server PC 40.

Now, each processing executed in the document management system according to a first exemplary embodiment of the present invention will be described in detail below.

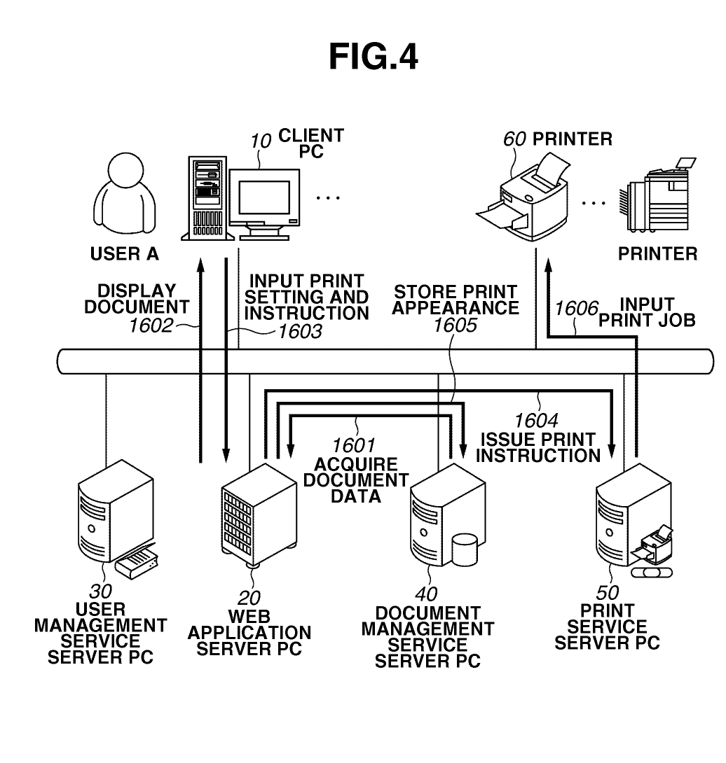

FIG. 4 is a schematic diagram illustrating print processing executed in the document management system according to the present exemplary embodiment.

Referring to FIG. 4, when the user A performs an operation for accessing (login into) the document management system via the web browser 10a of the client PC 10, a login request is transmitted. Then, the web application server PC 20 executes login processing. The web application server PC 20 accesses the user management service server PC 30 and executes processing for logging into the document management system.

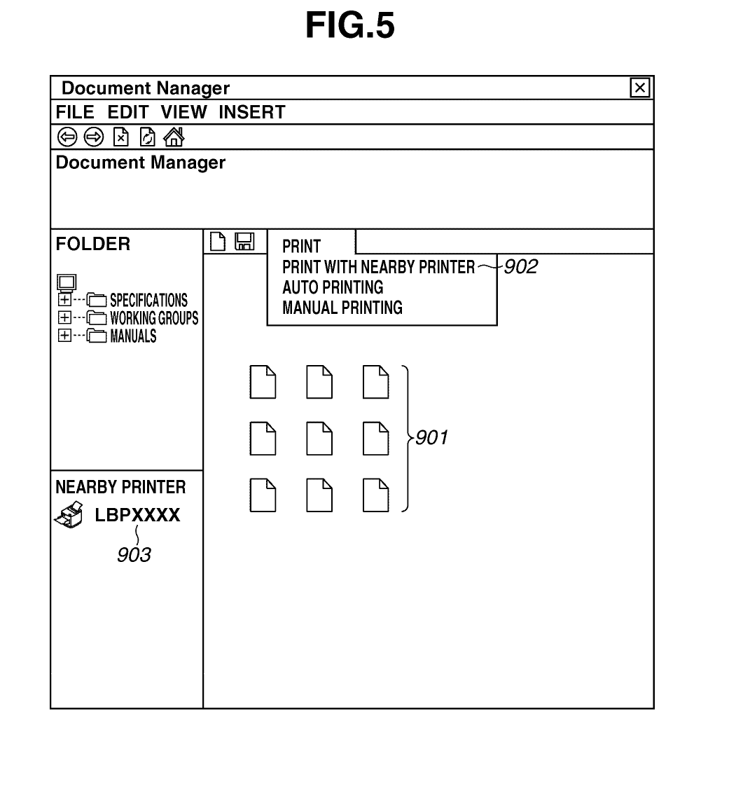

When the login processing is successfully completed, the web application server PC 20 transmits a screen illustrated in FIG. 5 to the client PC 10. The screen illustrated in FIG. 5 is displayed on a display 108 of the client PC 10.

FIG. 5 illustrates an example of a document list screen displayed on the display 108 illustrated in FIG. 2 as a web UI. The screen is displayed by the web browser 10a of the client PC 10.

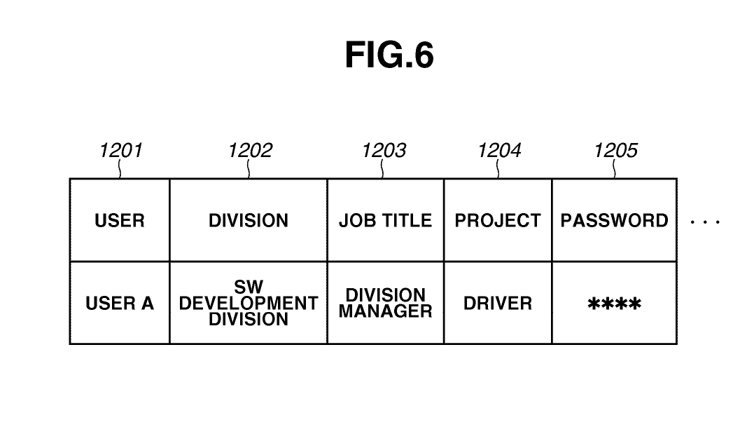

In the present exemplary embodiment, it is assumed that user information illustrated in FIG. 6 has been previously registered on the user management service server PC 30.

FIG. 6 illustrates an example of user information registered on the user management service server PC 30. Referring to FIG. 6, the user information includes various information, such as a user name 1201, a user division 1202, a user job title 1203, a project name 1204, and a password 1205.

When the user A selects an icon corresponding to a specific document from among those indicated in a document information field 901 in the web UI screen (FIG. 5), the web browser 10a of the client PC 10 transmits information corresponding to the selected icon (issues an instruction for displaying the document data of the document corresponding to the selected icon) to the web application server PC 20.

After receiving the information about the selected icon, in processing 1601 illustrated in FIG. 4, the web application server PC 20 acquires the document data corresponding to the selected icon from the document information storage unit 401 of the document management service server 40.

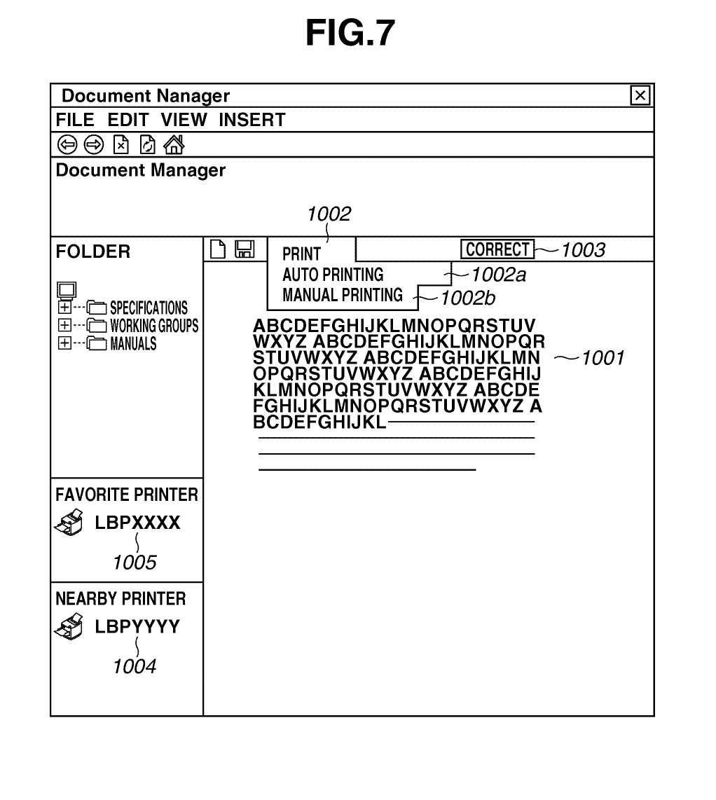

In processing 1602 illustrated in FIG. 4, the web application server PC 20 generates a web UI (illustrated in FIG. 7) as display data for displaying the content of the acquired document data. Then, the web application server PC 20 transmits the generated display data to the web browser 10a. After receiving the display data from the web application server PC 20, the web browser 10a displays the received display data. Thus, the client PC 10 can display the content of the document data as illustrated in a field 1001 in FIG. 7 even when an application program that can handle the document data has not been installed.

FIG. 7 illustrates an example of a document display screen displayed on the display 108 as a web UI illustrated in FIG. 2, according to the present exemplary embodiment. The screen illustrated in FIG. 7 is displayed by the web browser 10a of the client PC 10.

When the user A operates a correction button 1003 to issue a document correcting or editing instruction after editing document data 1001 in the web UI (FIG. 7) displayed by the web browser 10a of the client PC 10, the content of the correction (extended Markup Language (XML) data, for example) is transmitted from the web browser 10a to the web application server PC 20. The transmitted content of the correction is stored in the document information storage unit 401 of the document management service server 40 via the web application server PC 20.

When the user A operates a “manual printing” tab 1002b via the web UI (FIG. 7) displayed on the web browser 10a of the client PC 10 and issues an instruction for transmitting document data and a print setting (including information about the layout such as N-up printing and the number of prints) and an instruction for printing the document data, the web browser 10a of the client PC 10 detects the user operation. After detecting the user operation, in processing 1603 in FIG. 4, the web browser 10a of the client PC 10 transmits the print instruction (instruction for printing XML data, for example) including the print setting to the web application server PC 20.

After receiving the print instruction (instruction for printing XML data, for example) including the print setting from the web browser 10a, in processing 1604 (print instruction processing) in FIG. 4, the web application server PC 20 transmits the print setting information and the document data to the print service server PC 50.

Then, the print service server PC 50 stores the received print setting information (XML data, for example) and the document data in the storage area (the document data and information storage unit 501). Furthermore, the print service server PC 50 activates a local application program that can handle the stored document data and reads the document data by using the application program.

Then, the print service server PC 50 reads the print setting and prints the document data with the activated application program. More specifically, in processing 1606 (print job inputting processing) illustrated in FIG. 4, the print service server PC 50 generates print data of the received document data based on the received print setting information. Then, the print service server PC 50 transmits the generated print data to the printer 60. In addition, the print service server PC 50 issues an instruction for printing the print data to the printer 60.

In processing 1605 illustrated in FIG. 4, the web application server PC 20 transmits the document data and the print setting information to the print service server PC 50. At the same time, the web application server PC 20 transmits the print setting information to the document management service server 40 and stores the print setting information thereon. More specifically, the web application server PC 20 transmits the information about the user who has instructed the printing, the information about the document whose printing has been instructed, and the print setting information designated by the user instruction to the document management service server 40 and stores them thereon.

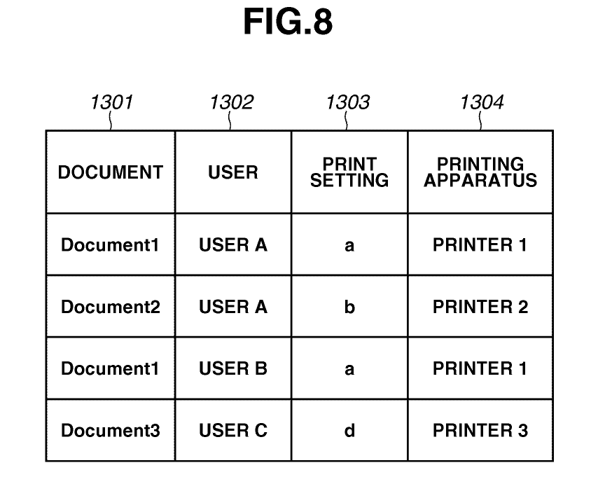

Then, the document management service server 40 associates the received print setting information with the document name and stores the print setting information in the document information storage unit 401 as a print history, as illustrated in FIG. 8. In the present exemplary embodiment, the document name is used as information for identifying the printed document data.

FIG. 8 illustrates an example of print history information, which is managed on the document information storage unit 401 illustrated in FIG. 3 according to the present exemplary embodiment.

The print history information illustrated in FIG. 8 includes identification information for identifying document data (document name) 1301, identification information for identifying a user (user name) 1302, identification information 1303 for identifying a print setting, and identification information (printing apparatus name) 1304 for identifying a printing apparatus used in a job, which are associated with one another. In the present exemplary embodiment, the print history information is recorded in the document information storage unit 401 each time document data is printed.

In the present exemplary embodiment, the document management system refers to the user information (FIG. 6) registered on the user management service server PC 30 based on user identification information (user name, for example). Accordingly, the document management system can acquire a history of use of the attribute of the user who has issued a print instruction with the print setting information used when the document information managed by the document management service server 40 was printed.

More specifically, in the document management system, the document information managed by the document management service server 40 is associated with the print setting information used when the document information was printed. Furthermore, in the document management system, the attribute of the user who has issued the print instruction with the print setting information is stored as a history in association with the print setting information.

In addition, the document management system uses the document identification information 1301 to refer to a document attribute (not illustrated) to be registered on the document management service server 40. Accordingly, the document management system can acquire a history of use of the document attribute in the printed document information. More specifically, in the document management system, a history of use of the document attribute of the document information whose printing with the print setting information has been instructed by the user is stored in association with the print setting information used when the document information managed by the document management service server 40 was printed.

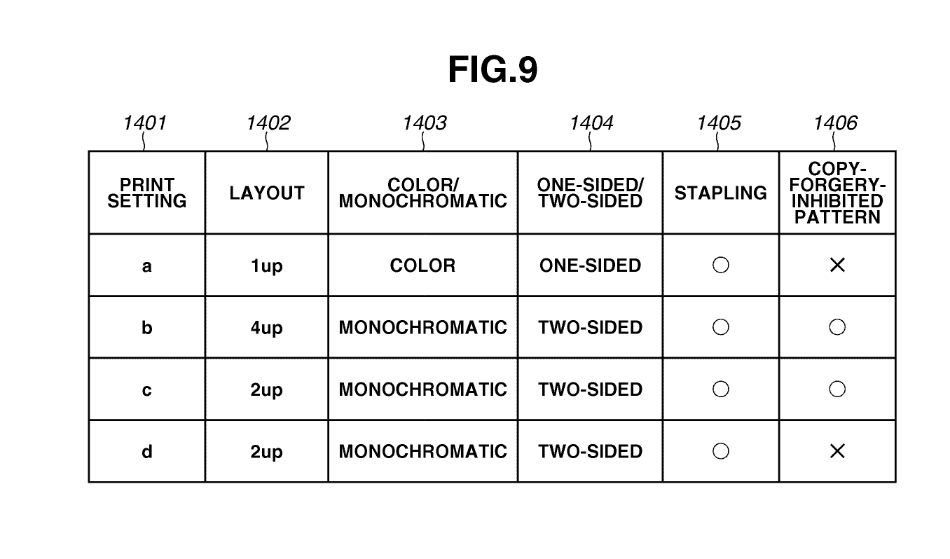

FIG. 9 illustrates an example of a detailed print setting recorded on the document information storage unit 401 according to the present exemplary embodiment.

Referring to FIG. 9, a number of pages (impositions) to be printed on one page 1402, a color mode (color/monochromatic) 1403, one-sided/two-sided 1404, whether to execute stapling 1405, and whether to embed copy-forgery-inhibited pattern 1406 are linked with print setting information identification information 1401 and managed as the print setting.

If a document is printed with the print setting 1406 (whether to embed a copy-forgery-inhibited pattern on the document) “ON” (i.e., marked with a circular mark (“∘”) in FIG. 9), then a copy-forgery-inhibited pattern including a hidden image is printed in the background of the document. The hidden image may include a special text string or image constituted by fine dots and becomes visible when copied. The copy-forgery-inhibited pattern includes information that indicates inhibition of copying the document, such as “COPY INHIBITED” or “FOR INTERNAL USE ONLY”, information about the user who has instructed the printing of the document, and information about addresses for distribution as a hidden text string. By using the copy-forgery-inhibited pattern, unauthorized disclosure or possible leakage of information can be prevented. Furthermore, the user who has instructed the printing of the document can be identified.

In the document management system, when a document is printed with a new print setting, the print setting is recorded in the document information storage unit 401. The print setting illustrated in FIG. 9 is just an example. That is, various setting different from the print settings 1402 through 1406 (illustrated in FIG. 9) can be included in the setting.

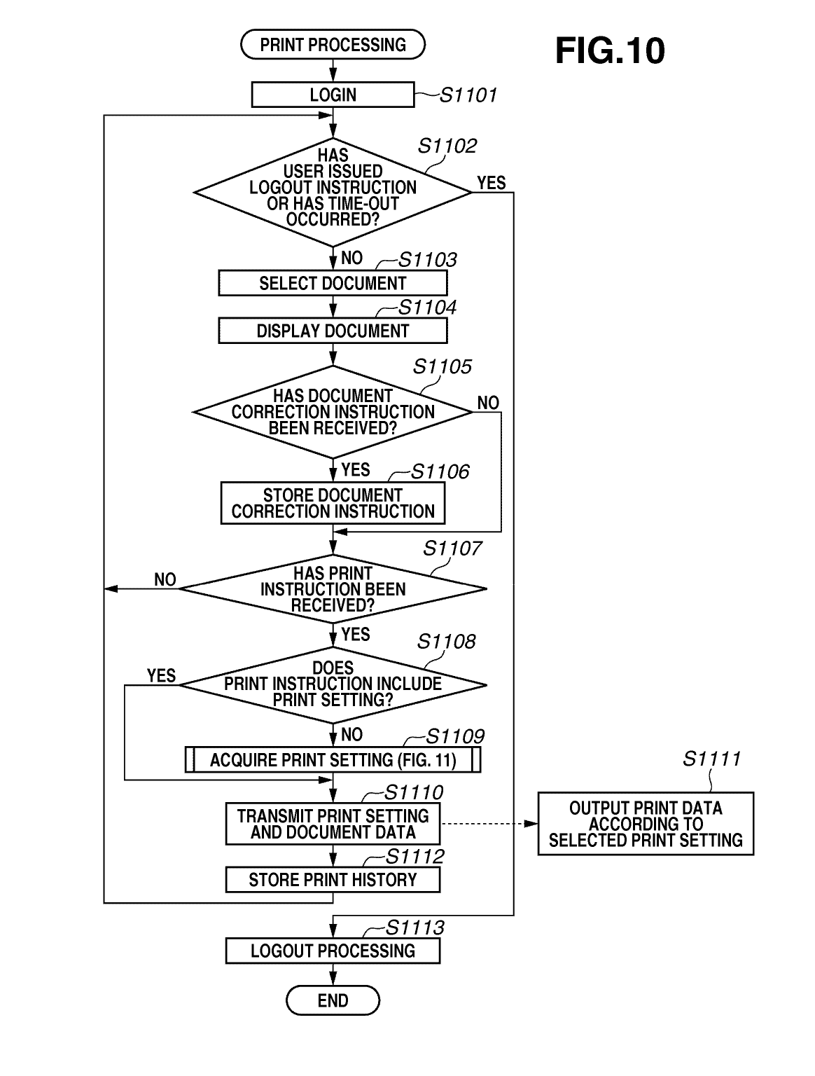

FIG. 10 is a flow chart illustrating a series of exemplary print processing executed by the web application server PC 20 according to the present exemplary embodiment. The processing in the flow chart in FIG. 10 is executed by the main control unit 200 of the web application server PC 20.

More specifically, the processing of the flow chart in FIG. 10 is executed with the CPU 100 of the web application server PC 20 by loading and executing the program stored on the external memory 109.

When the user issues a login instruction via the web UI displayed on the client PC 10, authentication information, such as a user name and a password, is transmitted to the web application server PC 20. After the authentication information is input to the main control unit 200 via the data transmitting and receiving unit 201, in step S1101, the main control unit 200 accesses the user management service server PC 30 and executes the login processing. If the login processing is successfully completed, then the processing advances to step S1102.

In step S1102, the main control unit 200 determines whether to execute logout processing. More specifically, if the user has issued a logout instruction via the web UI or if timeout has occurred, then the main control unit 200 determines that the logout processing is to be executed.

If it is determined that logout processing is to be executed (YES in step S1102), then the processing advances to step S1113. In step S1113, the main control unit 200 executes the logout processing. Then, the processing ends.

On the other hand, if it is determined that logout processing is not to be executed (NO in step S1102), then the processing advances to step S1103.

In step S1103, the main control unit 200 generates the web UI (illustrated in FIG. 5) using the web UI generation unit 203. In addition, the main control unit 200 transmits the generated web UI to the client PC 10 via the data transmitting and receiving unit 201 to display the generated web UI on the client PC 10.

When the web browser 10a of the client PC 10 receives the web UI, the web UI illustrated in FIG. 5 is displayed on the display 108 of the client PC 10.

When the user selects a document from the document information 901 on the web UI (illustrated in FIG. 5), the document selection instruction is transmitted from the web browser 10a of the client PC 10 to the web application server PC 20. The document selection instruction is input to the main control unit 200 via the data transmitting and receiving unit 201.

After the main control unit 200 has received the document selection instruction in step S1103, the processing advances to step S1104.

In step S1104, the main control unit 200 issues an instruction to the document information operation unit 400 of the document management service server PC 40 for acquiring the selected and instructed document data from the document information storage unit 401. Furthermore, the main control unit 200 instructs the web UI generation unit 203 to generate a web UI illustrated in FIG. 7 based on the acquired document data (display data for displaying the content of the document data (display data generation function). In addition, the main control unit 200 transmits the generated web UI to the client PC 10 via the data transmitting and receiving unit 201 to display the generated web UI on the client PC 10.

When the web browser 10a of the client PC 10 receives the web UI, the web UI illustrated in FIG. 7 is displayed on the display 108 of the client PC 10.

When the user instructs correction of document data via the web UI displayed in the above-described manner, the document data correction instruction is transmitted to the web application server PC 20 and is input to the main control unit 200 via the data transmitting and receiving unit 201.

In step S1105, the main control unit 200 determines whether the document correction instruction has been received from the client PC 10.

If it is determined that the document correction instruction has been received from the client PC 10 (YES in step S1105), then the processing advances to step S1106.

In step S1106, the main control unit 200 stores the document correction instruction received from the client PC 10 in the document information storage unit 401 via the document information operation unit 400 of the document management service server 40. Furthermore, the main control unit 200 issues an instruction to the web UI generation unit 203 for updating the web UI with the corrected content. Thus, the web UI displayed on the client PC 10 is updated. Then, the processing advances to step S1107.

On the other hand, if it is determined that no document correction instruction has been received from the client PC 10 (NO in step S1105), then the processing advances to step S1107.

The user can issue an instruction for printing the document data via the web UI displayed on the client PC 10. When the user issues the document data print instruction, the document data print instruction is transmitted to the web application server PC 20 and is input to the main control unit 200 via the data transmitting and receiving unit 201.

In the present exemplary embodiment, the print instruction includes “auto printing” 1002a and “manual printing” 1002b as illustrated in FIG. 7. When the user has selected the “auto printing” 1002a, the print instruction transmitted to the web application server PC 20 does not include the print setting information. On the other hand, when the user has selected the “manual printing” 1002b, the print instruction transmitted to the web application server PC 20 includes the print setting information (the print setting information is added to the print instruction).

In step S1107, the main control unit 200 of the web application server PC 20 determines whether a document print instruction has been received from the client PC 10. If it is determined that a document print instruction has been received from the client PC 10 (YES in step S1107), then the processing advances to step S1108.

In step S1108, the main control unit 200 determines whether the print setting information has been added to the received print instruction. If it is determined that the print setting information has not been added to (included in) the received print instruction (NO in step S1108), then the processing advances to step S1109.

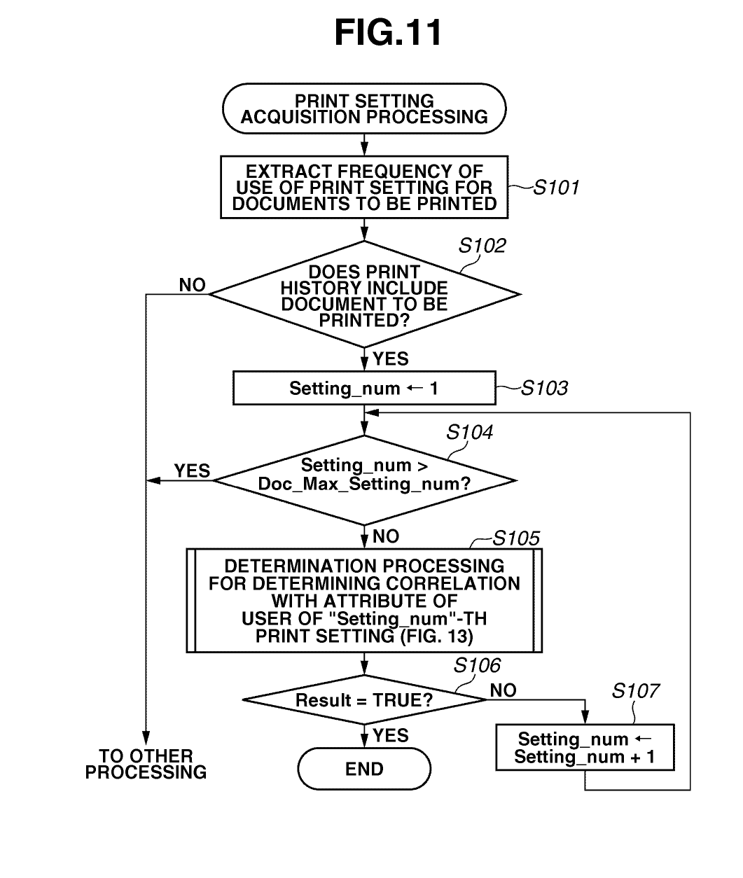

In step S1109, the main control unit 200 executes print setting information acquisition processing. The main control unit 200 acquires the print setting information and information for identifying the printing apparatus to be used from the print setting information acquisition unit 404. Then, the processing advances to step S1110. The print setting information acquired in step S1109 is the print setting information set on the document whose printing has been instructed by the user via web UI displayed on the client PC 10. The print setting information acquisition processing in step S1109 will be described in detail later below with reference to FIG. 11.

On the other hand, if it is determined that the print setting information has been added to (included in) the received print instruction (YES in step S1108), then the processing advances to step S1110.

In step S1110, the main control unit 200 transmits the document data to be printed, the acquired print setting information, and the information for identifying the printing apparatus to be used (the printer name) to the print service server PC 50 and stores them in the document data and information storage unit 501.

It is also useful if the main control unit 200 generates a web UI with the web UI generation unit 203 which indicates a message such as “The document data has been output to Printer 1” or the like based on the information for identifying the printing apparatus to be used. In this case, the main control unit 200 transmits the generated web UI to the client PC 10 and displays the generated web UI on the client PC 10. In this case, on the web browser 10a of the client PC 10, the received web UI (message) is displayed on the display 108.

In step S1111, the document data input monitoring unit 502 of the print service server PC 50 acquires the document data and the print setting information stored in the document data and information storage unit 501 and outputs the acquired document data and print setting information to the document data interpretation unit 503.

The document data interpretation unit 503 uses the print setting information and the information for identifying the printing apparatus to be used, which have been acquired from the document data and information storage unit 501 by using the print data generation unit 504 and generates print data of the acquired document data. The communication control unit 505 transmits the print data generated by the print data generation unit 504 to the printer 60 that corresponds to the information for identifying the printing apparatus to be used. Then, the printer 60 prints the received print data.

Furthermore, in step S1112 (approximately at the same time as executing the processing in step S1110), the main control unit 200 stores the history of printing for the document data in the document information storage unit 401 via the document information operation unit 400. The print history includes the document name, the user name, and the print setting information including the information about the printing apparatus used in the printing. Then, the processing returns to step S1102 and the main control unit 200 repeats the above-described processing.

On the other hand, if it is determined that no document print instruction has been received from the client PC 10 (NO in step S1107), then the processing returns to step S1102 and the main control unit 200 repeats the above-described processing.

It is also useful if the print setting includes “semi-manual printing” in addition to the “auto printing” 1002a and the “manual printing” 1002b. In this case, the following processing is executed.

That is, in the above-described “semi-manual printing”, after acquiring the print setting in step S1109, the main control unit 200 generates the web UI according to the acquired print setting. Then, the main control unit 200 may transmit the generated web UI to the client PC 10 to display (present) the received web UI (print setting information presentation processing). In this case, the web browser 10a of the client PC 10 displays (presents) the received web UI on the display 108.

Furthermore, in this case, the user who has viewed the displayed (presented) print setting issues an instruction for determining the print setting. The user can edit (change) the print setting before finally determining it. Then, the determined print setting is transmitted from the client PC 10 to the web application server PC 20. Then, the print setting is input to the main control unit 200 via the data transmitting and receiving unit 201. After the main control unit 200 has received the print setting from the client PC 10, the processing advances to step S1110. Above-described configuration may be useful for an exemplary embodiment of the present invention.

Now, the print setting acquisition processing (step S1109 in FIG. 10) will be described in detail below with reference to FIG. 11. If a user desires to print a document that the user has never printed, the user may not know which print setting is appropriate for printing the document. In this case, in the present exemplary embodiment, a print setting that has been frequently used for printing the document is selected from among those stored in the print history of the document to be printed.

Furthermore, a specific type of user may frequently use the same specific print setting. Considering this user tendency of frequently using the same print setting, the present exemplary embodiment determines whether the attribute of a user who is correlated with the print setting selected as a frequently used print setting is correlated with the user who has issued the print instruction. Accordingly, the present exemplary embodiment can automatically select a frequently used print setting that also matches the user attribute as the print setting for the document to be printed.

The print setting acquisition processing will be described in detail below with reference to the flow chart illustrated in FIG. 11. FIG. 11 is a flow chart illustrating exemplary print setting acquisition processing (step S1109 in FIG. 10) according to the first exemplary embodiment of the present invention. The processing according to the flow chart of FIG. 11 is executed by the main control unit 200 of the web application server PC 20 (FIG. 3). More specifically, the processing in the flow chart of FIG. 11 is executed with the CPU 100 of the web application server PC 20 by loading and executing the program stored on the external memory 109.

In executing this processing, the main control unit 200 stores various types of variables in the work area on the RAM 101 of the web application server PC 20. More specifically, variables “Setting_num”, “Doc_MAX_Setting_num”, and “Result” are stored on the RAM 101. The variable “Setting_num” is a reference counter used for serially referring to the print settings used in printing each document. The variable “Doc_MAX_Setting_num” stores the total number of the print settings used in printing each document. The variable “Result” stores the result of executing separately defined processing.

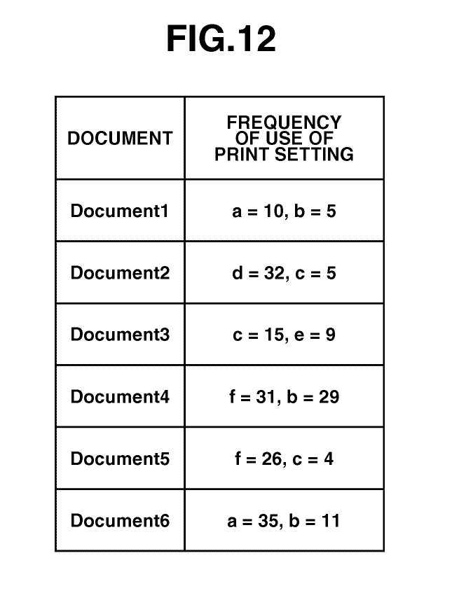

Referring to FIG. 11, in step S101, the main control unit 200 issues an instruction to the document information operation unit 400 for extracting the frequency of use of the print setting information illustrated in FIG. 12 from the print history stored in the document information storage unit 401. The document information operation unit 400 sorts the extracted print setting information in descending numeric order of the frequency of use thereof.

FIG. 12 illustrates the frequency of use of the print setting information extracted from the print history stored in the document information storage unit 401 illustrated in FIG. 3 in step S101 in FIG. 11 according to the present exemplary embodiment. In FIG. 12, among print setting information “a” through “f”, each of the print setting information “a” through “d” is equivalent to each of the print setting information “a” through “d” illustrated in FIG. 9. Furthermore, numerical values set to the print setting information “a” through “f” indicate the frequency of use of the corresponding print setting information. In the example illustrated in FIG. 12, the print settings are sorted in descending numeric order of frequency of use.

In step S102, the main control unit 200 determines whether the print history includes the document to be printed based on the information about the frequency of use of the print setting of each document extracted in step S101.

If it is determined that the print history does not include the document to be printed (that is, if the document to be printed does not have a print history) (NO in step S102), then the main control unit 200 executes the following processing.

In this case, the main control unit 200 displays a message indicating that the document has no print history on the web browser 10a of the client PC 10 to prompt the user to manually input the print setting. Alternatively, the main control unit 200 may acquire a default print setting that has been previously set by an administrator of the system. Further alternatively, the main control unit 200 may determine the print setting information whose frequency of use is the highest among those included in the print history stored in the document information storage unit 401 as the print setting information to be used in the printing to be executed.

On the other hand, if it is determined that the print history includes the document to be printed (that is, if the document to be printed has a print history) (YES in step S102), then the processing advances to step S103.

In step S103, the main control unit 200 sets a parameter value “1” to the reference counter “Setting_num” of the extracted print setting information. Then, the processing advances to step S104. The total number of print settings “Doc_MAX_Setting_num” stores the total number of the print settings that have been set and used for printing the document to be printed and that have been determined to exist in the print setting in step S102. In this regard, in printing a document “Document 1”, in the example illustrated in FIG. 12, two print settings “a” and “b” exist. Accordingly, the parameter value “2” is set to the print setting “Doc_MAX_Setting_num”.

In step S104, the main control unit 200 determines whether the value of the reference counter “Setting_num” is greater than the value of the total number of print settings “Doc_MAX_Setting_num” that has been used in printing the document. If it is determined that the value of the reference counter “Setting_num” is greater than the value of the total number of print settings “Doc_MAX_Setting_num” that has been used in printing the document (YES in step S104), then the main control unit 200 executes the above-described other processing as the main control unit 200 does if it is determined “NO” in step S102.

On the other hand, if it is determined that the value of the reference counter “Setting_num” is not greater than the value of the total number of print settings “Doc_MAX_Setting_num” (NO in step S104), then the processing advances to step S105.

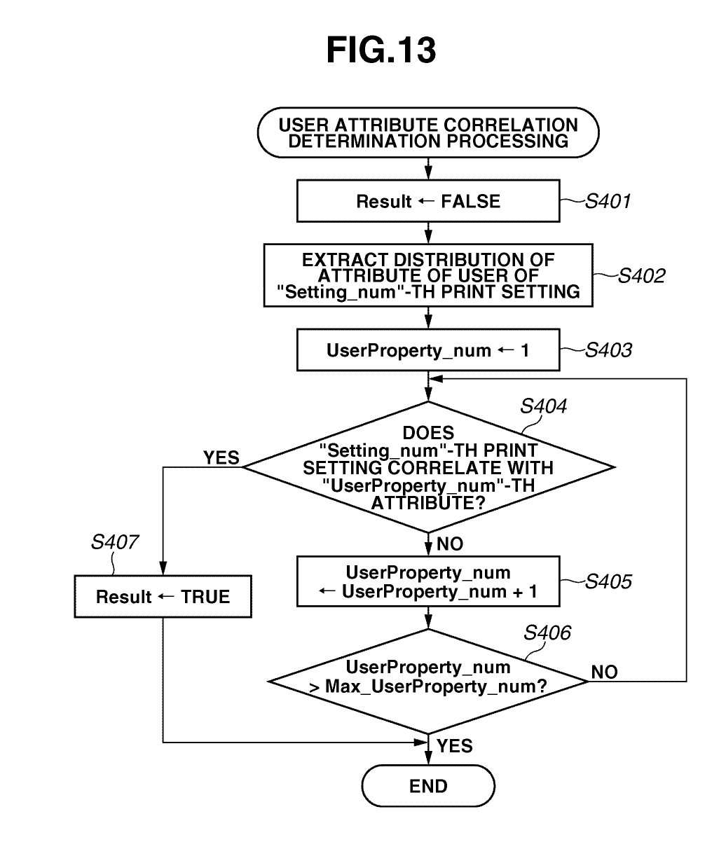

In step S105, the main control unit 200 executes user correlation determination processing illustrated in FIG. 13. By executing the user correlation determination processing, the main control unit 200 determines whether the attribute of the user correlated with a “Setting_num”-th print setting matches (“True”) with the attribute of the user who has instructed the printing or not (“False”).

The result of the processing (“True” or “False”) is stored in the variable “Result”. Because the print setting information has been sorted in descending numeric order of frequency of use of the print setting, the processing in step S105 is executed in the order of frequency of use of the print setting.

In step S106, the main control unit 200 determines whether the variable “Result”, which is obtained as a result of executing the processing in step S105, indicates “True”. If it is determined that the variable “Result” does not indicate “True” (NO in step S106), then the processing advances to step S107. In step S107, the main control unit 200 increments the reference counter “Setting_num”. Then, the processing returns to step S104 to execute the processing of the print setting information whose frequency of use is the next highest.

On the other hand, it is determined that the variable “Result” indicates “True” (YES in step S106), then the main control unit 200 determines (selects) the “Setting_num”-th print setting information as the print setting information to be used.

Then, the main control unit 200 issues an instruction to the print setting information acquisition unit 404 for acquiring the determined (selected) print setting information. Then, the processing ends.

The main control unit 200 may determine the printing apparatus to be used according to the acquired print setting information.

More specifically, the main control unit 200 may determine a printing apparatus whose frequency of use is the highest among the printing apparatuses associated with the acquired print setting information in the print history as the printing apparatus to be used. Alternatively, the main control unit 200 may determine the printing apparatus to which the acquired print setting information can be set and whose frequency of use is the highest, which is included in the print history, as the printing apparatus to be used.

Then, the processing advances to step S1110 in FIG. 10. As described above, in step S1110 in FIG. 10, the main control unit 200 transmits the determined (selected) and acquired print setting information and document data to the print service server PC 50. After receiving the print setting and the document data, the print service server PC 50 generates print data of the document data with the received print setting. Then, the printer 60 prints the generated print data.

Now, the user correlation determination processing illustrated in step S105 in FIG. 11 will be described in detail below.

In the user correlation determination processing, the user selects the print setting that has been used by another user having an attribute similar to that of the user (the user who issues the print instruction). Accordingly, the main control unit 200 compares the attribute of the user who is correlated with the selected print setting and the attribute of the user who instructs the printing and determines whether the user attributes mutually match.

In the user correlation determination processing, the main control unit 200 stores variables “UserProperty_num” and “MAX_UserProperty_num” in the work area of the RAM 101 of the web application server PC 20. The variable “UserProperty_num” is a reference counter for referring to the user attribute. The variable “MAX_UserProperty_num” stores the total number of user attributes. If the user attributes illustrated in FIG. 6 have been set, for example, the main control unit 200 refers to information such as “division”, “job title”, and “project” while incrementing the variable “UserProperty_num”.

The processing will be described in detail below with reference to a flow chart of FIG. 13.

FIG. 13 is a flow chart illustrating exemplary user correlation determination processing (step S105 in FIG. 11) according to the first exemplary embodiment of the present invention. The processing in the flow chart of FIG. 13 is executed by the main control unit 200 of the web application server PC 20.

More specifically, the processing in the flow chart of FIG. 13 is executed with the CPU 100 of the web application server PC 20 by loading and executing the program stored on the external memory 109.

Referring to FIG. 13, in step S401, the main control unit 200 initializes the variable “Result” in the work area of the RAM 101 with a parameter value “FALSE”. Then, the processing advances to step S402.

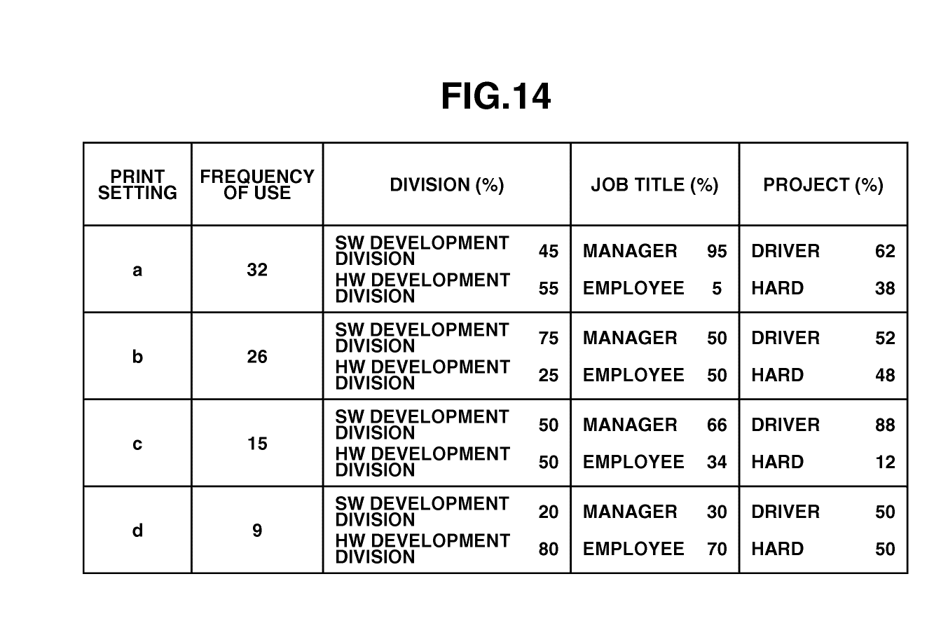

In step S402, the main control unit 200 issues an instruction to the document information operation unit 400 for extracting the distribution of the user attributes of a “Setting_num”-th print setting. In this regard, if the printing of the document “Document 1” has been instructed and the value of the variable “Setting_num” is “2”, then the main control unit 200 instructs the document information operation unit 400 to extract the distribution of the user attributes of the print setting “b” illustrated in the second row of the table in FIG. 14.

FIG. 14 illustrates an example of a user attribute extracted in step S402 in FIG. 13 according to the present exemplary embodiment. In the example illustrated in FIG. 14, the user attributes, such as the frequency of use, a division of the user, a job title of the user, and a project, are illustrated with respect to the print settings “a” through “d”.

In step S403, the main control unit 200 initializes the variable “UserProperty_num” with a numerical value “1”. Furthermore, the main control unit 200 stores the total number of the user attributes in the variable “MAX_UserProperty_num”. In the example illustrated in FIG. 14, three user attributes, such as the frequency of use, the division of the user, the job title of the user, and the project, are used. Accordingly, a numerical value “3” is set to the variable “MAX_UserProperty_num”.

In step S404, the main control unit 200 issues an instruction to the document attribute/user attribute comparison unit 403 for determining whether a “UserProperty_num”-th user attribute of the user who has instructed the printing is correlated with a “Setting_num”-th print setting.

In this regard, the main control unit 200 determines that the user attribute is correlated with the print setting information if the ratio of the user attribute of the user A to the user attributes associated with the print setting information exceeds a predetermined threshold value. The threshold value can be previously set by the administrator and stored on the external memory 109 of the document management service server 40.

More specifically, if the threshold value is “60”, the document attribute/user attribute comparison unit 403 determines that the attribute “Software (SW) Development Division” of the user A is correlated with the print setting “b” as a result of the comparison between the attribute of the user A illustrated in FIG. 6 and the distribution of the user attributes for the print setting “b” illustrated in FIG. 14.

More specifically, the ratio of the user attribute “SW Development Division” of the user A to the user attribute “division”, which is associated with the print setting information “b”, is “75”, exceeding the threshold value “60”. Accordingly, in this case, the document attribute/user attribute comparison unit 403 determines that the user attribute “division” of the user “A” and the print setting “b” are correlated.

If it is determined by the document attribute/user attribute comparison unit 403 that the user attribute and the print setting information are correlated (YES in step S404), then the processing advances to step S407. In step S407, the main control unit 200 sets the value “TRUE” to the variable “Result”. Then, the processing ends. Then, the processing advances to step S106 in FIG. 11.

On the other hand, if it is determined by the document attribute/user attribute comparison unit 403 that the user attribute and the print setting information are not correlated (NO in step S404), then the processing advances to step S405. In step S405, the main control unit 200 increments the variable “UserProperty_num”. Then, the processing advances to step S406.

In step S406, the main control unit 200 determines whether the value identified by the reference counter “UserProperty_num” is greater than the value identified by the variable “MAX_UserProperty_num”. If it is determined that the reference counter “UserProperty_num” is not greater than the value identified by the variable “MAX_UserProperty_num” (NO in step S406), then the processing returns to step S404.

On the other hand, if it is determined that the value identified by the reference counter “UserProperty_num” is greater than the value identified by the variable “MAX_UserProperty_num” (YES in step S406), then the processing ends. Then, the processing advances to step S106 in FIG. 11.

With the above-described configuration, the present exemplary embodiment allow the user to correct, edit, and print a document stored on a server apparatus via the web browser if a dedicated application or a printer driver is not installed on a client PC.

In addition, according to the present exemplary embodiment having the above-described configuration, the user is not required to perform a particular operation for appropriately setting a print setting because the print setting information is automatically set in the above-described manner.

In addition, in the present exemplary embodiment, the print setting information that is highly correlated with the user attribute is selected from among those included in the print history of the document to be printed. Accordingly, the present exemplary embodiment can print the document with the print setting and the printing apparatus that the user may desire to use.

Furthermore, according to the present exemplary embodiment having the above-described configuration, it is not necessary for the user to perform a particular operation for selecting a printing apparatus appropriate for the document to be printed and the document can be printed by the automatically set printing apparatus.

A second exemplary embodiment of the present invention will now be described below. In the above-described first exemplary embodiment, the print setting information having a high correlation with the user attribute is acquired from among those included in the print history of the document to be printed. In the present exemplary embodiment, print setting information having a high correlation with the user attribute is acquired from among those included in the print history having a high correlation with the document to be printed.

If a user desires to print a document that the user has never printed, the user may not know which print setting is appropriate for printing the document. In this case, in the present exemplary embodiment, the print setting having a highest correlation with the document attribute of the document to be printed is selected from among those included in the print history of the document to be printed.

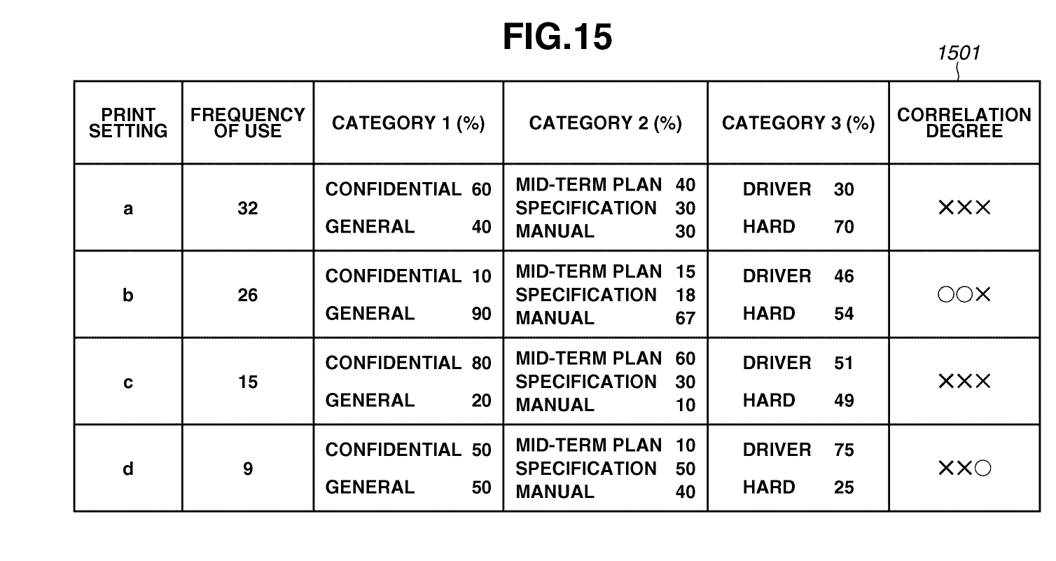

The processing will be described in detail below with reference to FIGS. 15 through 17. The system configuration, the hardware configuration, and the software configuration of the present exemplary embodiment are similar to those of the first exemplary embodiment.

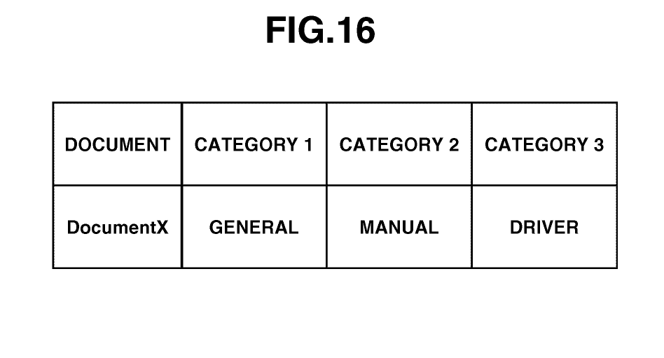

If the user desires to print a document illustrated in FIG. 16 having a print history illustrated in FIG. 15, the print setting “b”, which has a high correlation with the document attribute of the document to be printed, is selected as the print setting information to be used.

FIG. 15 illustrates an example of the distribution of the document attributes extracted by the document information operation unit 400 according to the print history information managed by the document information storage unit 401 (FIG. 3) according to the present exemplary embodiment.

The print history information managed by the document information storage unit 401 is associated with the document name 1301 as illustrated in FIGS. 8 and 9. Accordingly, the document information operation unit 400 can extract the document attributes (categories 1 through 3) of the document information printed using each print setting information by using the document name.

Furthermore, the document information operation unit 400 can extract the distribution of the document attributes of the document printed using each print setting information according to the extracted information.

FIG. 16 illustrates an example of document information managed by the document information storage unit 401 (FIG. 3) according to the present exemplary embodiment. Referring to FIG. 16, the document information storage unit 401 (FIG. 3) stores and manages attribute information of document information. In the present exemplary embodiment, three categories (categories 1 through 3) are used to manage the attribute information of the document information.

In each of the examples illustrated in FIGS. 15 and 16, the category 1 manages the security level of the document information. The security level can include “confidential”, “general”, or the like. The category 2 manages the document type of the document information. The document type can include “mid-term project”, “specification”, “manual”, or the like. The category 3 manages the document content of the document information. The document content can include parameters “driver” and “hardware”, which respectively indicate that the document content is related with the driver and the hardware.

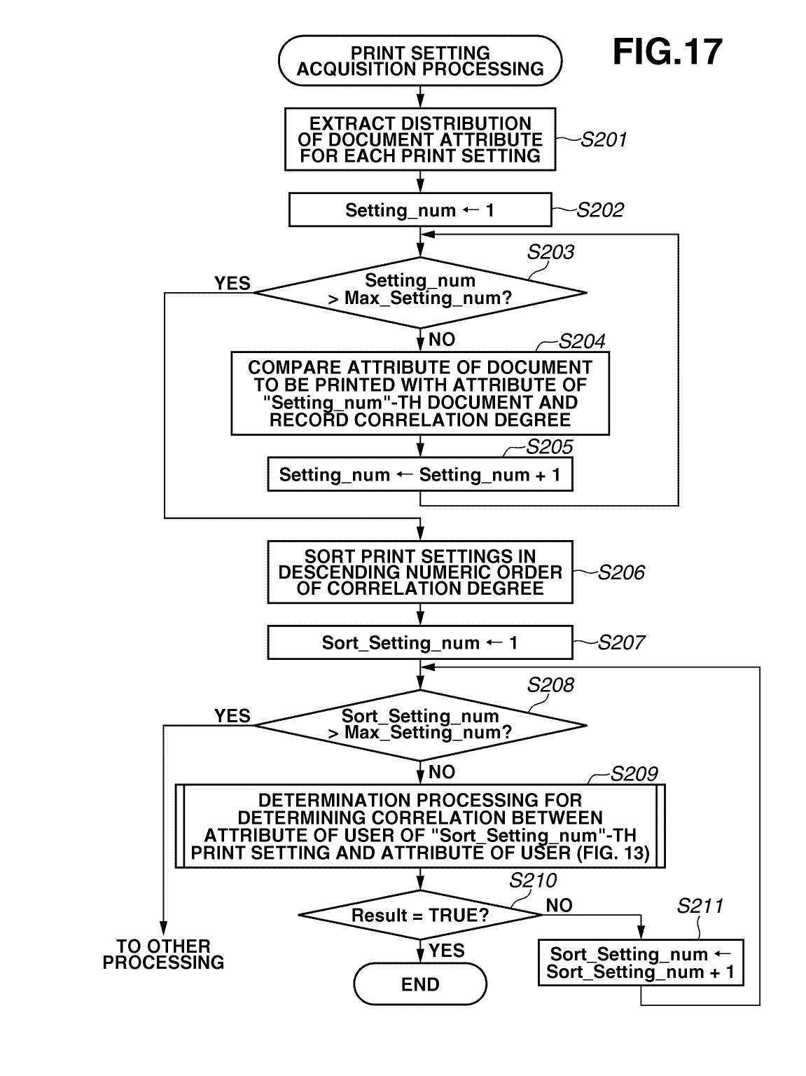

FIG. 17 is a flow chart illustrating exemplary print setting acquisition processing according to the second exemplary embodiment of the present invention. The processing in the flow chart is executed by the main control unit 200 of the web application server PC 20. More specifically, the processing in the flow chart is executed by the CPU 100 of the web application server PC 20 by loading and executing the program stored on the external memory 109.

In executing this processing, the main control unit 200 stores various types of variables in the work area on the RAM 101 of the web application server PC 20. More specifically, variables “Setting_num”, “MAX_Setting_num”, and “Sort_Setting_num” are stored on the RAM 101. The variable “Setting_num” is a reference counter used for serially referring to the print settings. The variable “MAX_Setting_num” stores the total number of the print settings. The variable “Sort_Setting_num” is a reference counter used for referring to the print settings sorted in descending numeric order of the degree of correlation with the document to be printed.

In addition, the main control unit 200 stores a variable “Result” in the work area of the RAM 101 of the web application server PC 20. The variable “Result” stores the result of processing separately defined.

Referring to FIG. 17, in step S201, the main control unit 200 issues an instruction to the document information operation unit 400 for extracting the distribution of the document attributes (FIG. 15) of each print setting from the print history stored on the document information storage unit 401.

In step S202, the main control unit 200 initializes the variable “Setting_num” with a numeric value “1”. In addition, the main control unit 200 stores the total number of print settings, which is extracted in step S201, in the total number of print settings “MAX_Setting_num”.

In step S203, the main control unit 200 determines whether the value identified by the reference counter “Setting_num” is greater than the value of the variable “MAX_Setting_num”. If it is determined that the value identified by the reference counter “Setting_num” is not greater than the value of the variable “MAX_Setting_num” (NO in step S203), the processing advances to step S204.

In step S204, the main control unit 200 issues an instruction to the document attribute/user attribute comparison unit 403 for comparing the distribution of the attributes of a “Setting_num”-th print setting and the document attribute of the document to be printed and determine the degree of correlation between them (document attribute comparison processing). Furthermore, the main control unit 200 associates the result of the determination (comparison) by the document attribute/user attribute comparison unit 403 in step S204 with the current print setting and stores the comparison result and the print setting on the RAM 101 of the web application server PC 20 for each category.

With respect to the degree of correlation, the document attribute/user attribute comparison unit 403 determines that the document attribute is highly correlated with the print setting information if the ratio of a specific document attribute to the document attributes associated with the print setting information exceeds a predetermined threshold value. On the other hand, the document attribute/user attribute comparison unit 403 determines that the correlation between the document attribute and the print setting information is low if the ratio of the specific document attribute to the document attributes associated with the print setting information does not exceed a predetermined threshold value. The threshold value is previously set by the administrator and stored on the external memory 109 of the document management service server 40.

If the user desires to print a document illustrated in FIG. 16 whose document attribute distribution is as illustrated in FIG. 15, the degree of correlation is recorded as illustrated in a correlation degree column 1501 (FIG. 15). A parameter value “∘” in FIG. 15 indicates that the corresponding print setting is correlated with the document attribute. A parameter value “×” in FIG. 15 indicates that the corresponding print setting is not correlated with the document attribute.

In the correlation degree column 1501 illustrated in FIG. 15, the parameter values (“∘” and “×”) indicate the results of determination for the categories 1 through 3. The leftmost parameter value in the correlation degree column 1501 corresponds to the determination result for the category 1. The middle parameter value corresponds to the determination result for the category 2. The rightmost parameter value corresponds to the determination result for the category 3. More specifically, in the case of the print setting “b”, the parameter values “∘”, “∘”, and “×” are set in this order. Accordingly, it can be recognized that the correlation between the corresponding print setting and the document attribute has been determined for the categories 1 and 2 while not for the category 3.

In step S205, the main control unit 200 increments the reference counter “Setting_num”. Then, the processing returns to step S203.

On the other hand, if it is determined that the value identified by the reference counter “Setting_num” is greater than the value of the variable “MAX_Setting_num” (YES in step S203), the processing advances to step S206.

In step S206, the main control unit 200 sorts the print settings extracted in step S201 in descending numeric order of the degree of correlation determined and recorded in step S204.

In sorting the print settings in descending order of the correlation degree, the main control unit 200 sorts the print settings in descending order of the number of circular marks (“∘”) identified in the correlation degree column 1501 (FIG. 15). That is, the main control unit 200 determines the ratio of the document attribute of the document information to be printed to the document attributes associated with the print setting information for each category of the document attribute.

Furthermore, the main control unit 200 determines the degree of correlation between the document attribute of the document information to be printed and the print setting information according to the number of categories (the number of circular marks in the correlation degree column 1501 in FIG. 15) whose above-described ratio exceeds the threshold value. More specifically, the degree of correlation between the print setting information and the document attribute of the document information to be printed, which is determined by the main control unit 200, becomes higher as the number of categories of the document attributes having a high correlation with the print setting information becomes greater.

If the number of the circular marks in the column 1501 are the same in all the categories, the main control unit 200 sorts the print settings in a predetermined priority order (in order of the category 1, the category 2, and the category 3, for example).

In step S207, the main control unit 200 initializes the sorting counter “Sort_Setting_num” with a numeric value “1”.

In step S208, the main control unit 200 determines whether the value identified by the counter “Sort_Setting_num” is greater than the value identified by the variable “MAX_Setting_num”. If it is determined that the value identified by the counter “Sort_Setting_num” is greater than the value identified by the variable “MAX_Setting_num” (YES in step S208), then the main control unit 200 executes the other processing.

In this regard, the main control unit 200 executes control for displaying a message indicating that the document has no print history on the web browser 10a of the client PC 10 to prompt the user to manually set a print setting. In this case, it is also useful if the main control unit 200 acquires a default print setting previously set by the administrator.

On the other hand, if it is determined that the value identified by the counter “Sort_Setting_num” is not greater than the value identified by the variable “MAX_Setting_num” (NO in step S208), then the processing advances to step S209.

In step S209, the main control unit 200 executes the user correlation determination processing illustrated in FIG. 13 as in the first exemplary embodiment (step S105 in FIG. 11). The user correlation determination processing is processing for determining whether the user attribute correlated with a “Sort_Setting_num”-th print setting matches (“True”) with the user attribute of the user who issues the print instruction.

The result of the processing (“True” or “False”) is stored in the variable “Result”. The processing in step S209 is executed in descending numeric order of the degree of correlation because the print setting information is sorted in descending order of correlation degree.

In step S210, the main control unit 200 determines whether the value “True” has been set to the variable “Result” as a result of executing the processing in step S209. If it is determined that the value “True” has not been set to the variable “Result” (NO in step S210), then the processing advances to step S211. In step S211, the main control unit 200 increments the reference counter “Sort_Setting_num”. Then, the processing returns to step S208.

On the other hand, if it is determined that the value “True” has been set to the variable “Result” (YES in step S210), then the main control unit 200 determines (selects) “Sort_Setting_num”-th print setting information as the print setting information to be used. Then, the main control unit 200 issues an instruction to the print setting information acquisition unit 404 for acquiring the determined (selected) print setting information. Then, the processing illustrated in FIG. 17 ends. Then, the processing advances to step S1110 in FIG. 10.

In step S1110 in FIG. 10, as described above, the main control unit 200 transmits the determined (selected) and acquired print setting information and document data to the print service server PC 50. After receiving the print setting and the document data, the print service server PC 50 generates print data of the document data using the print setting. Then, the printer 60 prints or outputs the generated print data.

With the above-described configuration, the present exemplary embodiment selects the print setting information having a high correlation according to the document attribute and the user attribute as the automatically set print setting information. Accordingly, the present exemplary embodiment can print a document with the print setting and the printing apparatus appropriate for the document and the user.

A third exemplary embodiment of the present invention will now be described below. In the above-described first exemplary embodiment, the print setting information having a high degree of correlation with the user attribute is acquired from those included in the print history of the document to be printed. In the above-described second exemplary embodiment, the print setting information having a high degree of correlation with the user attribute from among those included in the print history having a high degree of correlation with the document to be printed. In the present exemplary embodiment, a print setting that has been most frequently used is acquired if the print history does not include print setting information having a high degree of correlation with the user attribute.

If a user desires to print a document that the user has never printed, the user may not know which print setting is appropriate for printing the document. In this case, in the present exemplary embodiment, a print setting that has been most frequently used is selected from among those stored in the print history of the document to be printed.

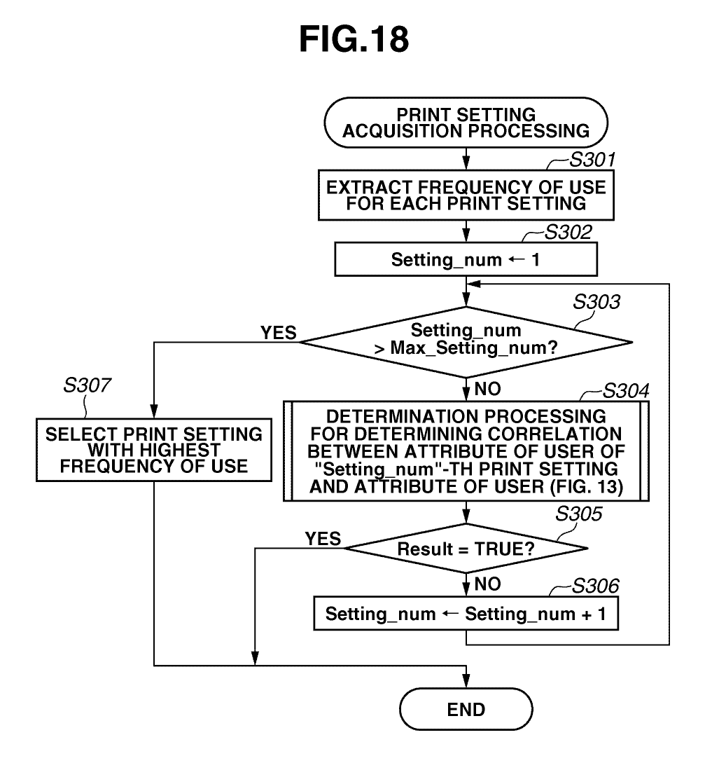

The processing according to the present exemplary embodiment will be described in detail below with reference to a flow chart illustrated in FIG. 18. The system configuration, the hardware configuration, and the software configuration of the present exemplary embodiment are the same as those of the first exemplary embodiment.

FIG. 18 is a flow chart illustrating exemplary print setting acquisition processing according to the third exemplary embodiment of the present invention. The processing in the flow chart of FIG. 18 is executed by the main control unit 200 of the web application server PC 20.

More specifically, the processing in the flow chart of FIG. 18 is executed with the CPU 100 of the web application server PC 20 by loading and executing the program stored on the external memory 109.

In executing this processing, the main control unit 200 stores various types of variables in the work area on the RAM 101 of the web application server PC 20. More specifically, variables “Setting_num”, “MAX_Setting_num”, and “Result” are stored on the RAM 101. The variable “Setting_num” is a reference counter used for serially referring to the print settings. The variable “MAX_Setting_num” stores the total number of the print settings. The variable “Result” stores the result of executing separately defined processing.

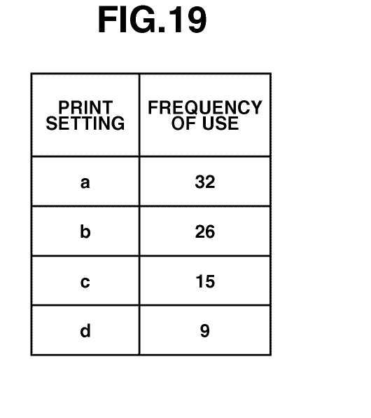

Referring to FIG. 18, in step S301, the main control unit 200 issues an instruction to the document information operation unit 400 for extracting the frequency of use of the print setting, which is illustrated in FIG. 19, from the print history stored on the document information storage unit 401. The document information operation unit 400 sorts the extracted print setting information in descending numeric order of frequency of use.

FIG. 19 illustrates the frequency of use of the print setting extracted from the print history stored on the document information storage unit 401 (FIG. 3) in step S301 in FIG. 18.

In step S302 (FIG. 18), the main control unit 200 initializes the reference counter “Setting_num” with a numeric value “1”. The print setting total number “MAX_Setting_num” stores the total number of print settings extracted in step S301.

In step S303, the main control unit 200 determines whether the value identified by the reference counter “Setting_num” is greater than the value identified by the variable “MAX_Setting_num”.

If it is determined that the value identified by the reference counter “Setting_num” is not greater than the value identified by the variable “MAX_Setting_num” (NO in step S303), then the processing advances to step S304.

In step S304, the main control unit 200 executes the user correlation determination processing illustrated in FIG. 13 as in the first exemplary embodiment (step S105 in FIG. 11). The user correlation determination processing is processing for determining whether the user attribute correlated with a “Setting_num”-th print setting matches (“True”) with the user attribute of the user who issues the print instruction.

The result of the processing (“True” or “False”) is stored in the variable “Result”. The processing in step S304 is executed in descending numeric order of the frequency of use because the print setting information is sorted in descending order of frequency of use.

In step S305, the main control unit 200 determines whether the value “True” has been set to the variable “Result” as a result of executing the processing in step S304. If it is determined that the value “True” has not been set to the variable “Result” (NO in step S305), then the processing advances to step S306. In step S306, the main control unit 200 increments the reference counter “Setting_num”. Then, the processing returns to step S303. On the other hand, if it is determined that the value “True” has been set to the variable “Result” (YES in step S305), then the main control unit 200 determines (selects) “Setting_num”-th print setting information as the print setting information to be used. Then, the main control unit 200 issues an instruction to the print setting information acquisition unit 404 for acquiring the determined (selected) print setting information. Then, the processing illustrated in FIG. 18 ends. Then, the processing advances to step S1110 in FIG. 10.

On the other hand, if it is determined that the value identified by the reference counter “Setting_num” is greater than the value identified by the variable “MAX_Setting_num” (YES in step S303), then the processing advances to step S307.

In step S307, the main control unit 200 determines (selects) the print setting information that has been most frequently used as the print setting information to be used, from among the print setting information extracted in step S301. Then, the main control unit 200 issues an instruction to the print setting information acquisition unit 404 for acquiring the determined (selected) print setting information. Then, the processing illustrated in FIG. 18 ends. Then, the processing advances to step S1110 in FIG. 10.

In step S1110 in FIG. 10, as described above, the main control unit 200 transmits the determined (selected) and acquired print setting information and document data to the print service server PC 50. After receiving the print setting and the document data, the print service server PC 50 generates print data of the document data with the print setting. Then, the printer 60 prints or outputs the generated print data.

With the above-described configuration, the present exemplary embodiment selects the print setting information that has been frequently used and having a high correlation with the user attribute from among those included in the print history as the automatically set print setting information. Accordingly, the present exemplary embodiment can print a document with the print setting and the printing apparatus that have been highly frequently used and appropriate for the user.

A fourth exemplary embodiment of the present invention will now be described below. In the above-described first exemplary embodiment, the print setting information having a high degree of correlation with the user attribute is acquired from those included in the print history of the document to be printed. In the above-described second exemplary embodiment, the print setting information having a high degree of correlation with the user attribute from among those included in the print history having a high degree of correlation with the document to be printed. In the above-described third exemplary embodiment, a print setting that has been most frequently used is acquired if the print history does not include print setting information having a high degree of correlation with the user attribute.

In the present exemplary embodiment, a method that is a combination of the print setting information acquisition methods in the first through the third exemplary embodiments is used. The method according to the present exemplary embodiment will be described in detail below. The system configuration, the hardware configuration, and the software configuration of the present exemplary embodiment are the same as those of the first exemplary embodiment.

As described above in the first exemplary embodiment, if it is determined by the main control unit 200 that a print history of the document to be printed exists in the document information storage unit 401, then the present exemplary embodiment selects a print setting that has been most frequently used in printing the document and having a correlation with the user attribute of the user who has instructed the printing of the document.

If it is determined that the document to be printed has no print history or if the print history, if any, of the document to be printed includes no print setting information having a high correlation with the user attribute, then the present exemplary embodiment executes the method according to the second exemplary embodiment.

As described above in the second exemplary embodiment, the main control unit 200 determines whether the document attribute correlated with the used print setting matches the document attribute of the document to be printed by referring to the print history of the document and whether the print setting is correlated with the user attribute of the user who has instructed the printing of the document.

If it is determined that the document attribute correlated with the used print setting matches the document attribute of the document to be printed and that the print setting is correlated with the user attribute of the user who has instructed the printing of the document, then the main control unit 200 selects the print setting as the print setting to be used.

On the other hand, if it is determined that the document attribute correlated with the used print setting does not match the document attribute of the document to be printed by referring to the print history of the document, then the main control unit 200 executes the method according to the third exemplary embodiment.

In this case, as described above in the third exemplary embodiment, the main control unit 200 determines whether the user attribute of the user who has used the print setting correlated with the print setting that has been highly frequently used matches the user attribute of the user who has instructed the printing of the document by referring to the print history of the document.

If it is determined that the user attribute of the user who has used the print setting correlated with the print setting that has been highly frequently used matches the user attribute of the user who has instructed the printing of the document, then the main control unit 200 selects the print setting as the print setting to be used.

On the other hand, if it is determined that the user attribute of the user who has used the print setting correlated with the print setting that has been highly frequently used does not match the user attribute of the user who has instructed the printing of the document, then the main control unit 200 selects the print setting that has been most frequently used.

The series of processing according to the present exemplary embodiment will be described with reference to the flow charts in FIGS. 11, 17, and 18. If it is determined “NO” in step S102 (FIG. 11) or if it is determined “YES” in step S104 (FIG. 11), then the processing advances to step S201 (FIG. 17). Furthermore, if it is determined “YES” in step S208 (FIG. 17), then the processing advances to step S301 (FIG. 18). Thus, the series of processing according to the present exemplary embodiment is executed.

With the above-described configuration, the present exemplary embodiment can print a document with the automatically set print setting information and the printing apparatus appropriate for the document and the user.

A fifth exemplary embodiment of the present invention will now be described below. In the present exemplary embodiment, information about the installation location of the printer 60 and each client PC 10 is managed by the user management service server PC 30. Furthermore, in the present exemplary embodiment, a menu “print with nearby printer” 902 (FIG. 5) is included in the web UI (FIG. 8).

If the user has instructed the printing by selecting the “print with nearby printer” menu 902 (FIG. 5), then the main control unit 200 identifies a printer located in the proximity of the client PC 10, on which the user has instructed the printing, according to the above-described installation location information.

The main control unit 200 may execute the print setting information acquisition processing described above in each of the first through the fourth exemplary embodiments. In this case, the main control unit 200 may acquire and determine the print setting information on condition that the printing is executed by using the nearby printer identified in the above-described manner.

More specifically, in this case, the main control unit 200 acquires the print setting information about the printing that has been executed by using the nearby printer identified in the above-described manner from the print history. Furthermore, the main control unit 200 executes the processing for acquiring the print setting information from among the acquired print setting information, which is described above in the first through the fourth exemplary embodiments.

With the above-described configuration, the present exemplary embodiment can print a document by using the printing apparatus located closely to the user and with the automatically set print setting appropriate for the document and the user.

During the login processing in step S1101 in FIG. 10, the main control unit 200 searches for a printer located close to the client PC 10, on which the user has instructed the login processing. In generating the web UI illustrated in FIGS. 5 and 7, the main control unit 200 may execute control for displaying the printers extracted as a result of the search as indicated in fields 903 and 1004 in FIGS. 5 and 7.

In this case, when the user logs into the system, the printers located close to the client PC 10 (where the user has issued the login instruction) are displayed on the screen.

In addition, during the login processing in step S1101 in FIG. 10, the main control unit 200 acquires the printer(s) that the user who belongs to the same division as the login user's (correlated user) frequently uses.

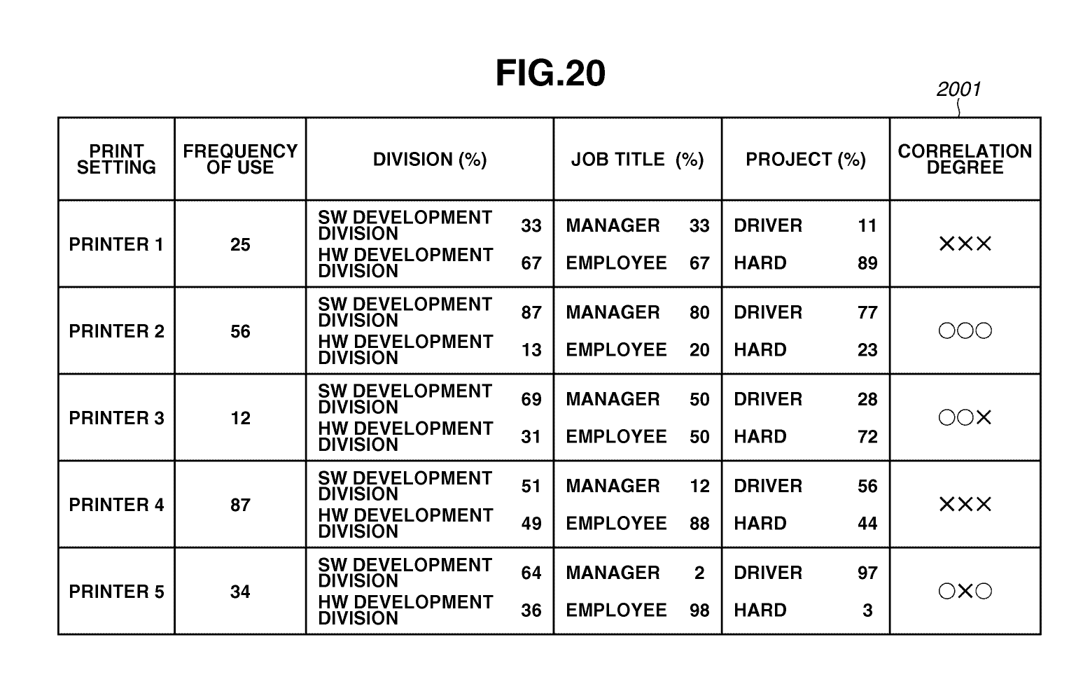

The main control unit 200 issues an instruction to the document information operation unit 400 for extracting the distribution of the user attributes (FIG. 20) for each printing apparatus from the print history stored on the document information storage unit 401. FIG. 20 illustrates an example of the distribution of the user attributes extracted from the print history for each printing apparatus according to the present exemplary embodiment.

Subsequently to the above-described processing, the main control unit 200 issues an instruction to the document information operation unit 400 for executing comparison between the distribution of the user attribute for each printing apparatus and the user attribute of the login user and determining the degree of correlation by using the document attribute/user attribute comparison unit 403 (login user attribute comparison processing). The main control unit 200 records the result of the determination by the document attribute/user attribute comparison unit 403 on the RAM 101 of the web application server PC 20 for each category in association with each printing apparatus.

With respect to the degree of correlation, the document attribute/user attribute comparison unit 403 determines that the user attribute is highly correlated with the printing apparatus if the ratio of a specific user attribute to the user attributes associated with the print setting information exceeds a predetermined threshold value (“60”, for example). The threshold value is previously set by the administrator and stored on the external memory 109 of the document management service server 40.

If the user attribute distribution illustrated in FIG. 20 has been extracted and if the login user is the user A (FIG. 6), then the main control unit 200 records the correlation degree as indicated in a correlation degree column 2001 in FIG. 20. If the correlation degree of an attribute is high, a circular mark “∘” is set in the column 2001. On the other hand, if the correlation degree of an attribute is not high, a cross (“×”) is set in the column 2001.

In the correlation degree column 2001 (FIG. 20), the parameter values set therein respectively indicates a result of determination for the division, the job title, and the project in this order from the left in FIG. 20. In the example illustrated in FIG. 20, the parameter values “∘”, “∘”, and “∘” are set in the column 2001 in this order with respect to a “Printer 2”. The determination results indicate that the division, the job title, and the project are correlated (highly related).

Furthermore, the main control unit 200 sorts the extracted printing apparatuses in descending order of correlation degree determined and recorded in the above-described manner.

In sorting the printing apparatuses in descending order of the correlation degree, the main control unit 200 sorts the printing apparatuses in descending order of the number of circular marks (“∘”) identified in the correlation degree column 2001 (FIG. 20). If the number of the circular marks in the column 2001 is the same in all the attributes, the main control unit 200 sorts the printing apparatuses in a predetermined priority order (in order of the division, the job title, and the project, for example).

Furthermore, the main control unit 200 determines the printing apparatus having the highest correlation degree (the “Printer 2” in FIG. 20) as the printer that has been frequently used by users belonging to the same division as the login user's division (correlated user). Alternatively, the degree of correlation with the user may be determined by only the attributes “division” and “project” except the attribute “job title”. Furthermore, a different other user attribute may be used instead or in addition to the above-described attributes.

In generating the web UI illustrated in FIGS. 5 and 7, the main control unit 200 can execute control for displaying the extracted printers that has been frequently used by the user belonging to the same division as the login user's division (correlated user) as indicated in a fields 1005 in FIG. 7.

If the above-described printing apparatus display (presentation) processing is executed, when the user has logs into the system, the printers that have been most frequently used by the user belonging to the same division as the login user's division (correlated user's division) are displayed on the screen.

The frequency of use of a specific printer may differ depending on each user belonging to a specific division. That is, if only a specific user frequently uses a specific printer, the frequency of use of the printer of the division may become high.

In this regard, it is also useful, in the case where a specific user has frequently used a specific printer, if the frequency of use of the printer by the specific user is not used in determining a most frequently used printer. In this case, the main control unit 200 can calculate the distribution of the ratio of frequency of use by each user and discard the calculation result of a user whose result exceeds the standard deviation. Thus, the present exemplary embodiment can appropriately determine the printer that is most frequently used in the login user's division.

The present invention can strictly manage a confidential document. If the administrator of the system desires to handle a document as a confidential document on the document management service server 40, the administrator can set a security setting “confidential” indicating that the document is confidential as the attribute of the document.

In this case, if a user who has no right to access the confidential document desires to print the confidential document via the web browser of the client PC 10, the present exemplary embodiment can execute the security setting so that the print setting (whether to apply copy-forgery-inhibited pattern 1406 in FIG. 9, for example) such as a “copy-forgery-inhibited pattern”, which is set as the security setting, cannot be disabled regardless of the selected print mode (the “auto printing”, the “manual printing”, or the “semi-manual printing”).

More specifically, if the user has selected the “semi-manual printing”, the main control unit 200 executes control for displaying (presenting) the determined print setting information on the display of the client PC on which the user has instructed the printing. In this case, although the presented print setting information can be edited by the user, the main control unit 200 executes control for displaying the print setting information so that the setting related to the data security in the print setting information (the setting of the function for printing the copy-forgery-inhibited pattern) can not be changed.

In the present invention, document data is not downloaded on a client PC. Furthermore, the client PC does not generate print data of the document data. Accordingly, in the system of the present invention, the print setting related to the data security can be surely and appropriately set for printing a confidential document.

Furthermore, even when the administrator of the system has not set a document as confidential, if a user issues an instruction for reprinting a document that has been printed with the print setting for securing the data security thereof (by using the copy-forgery-inhibited pattern, for example) at least once, it is also useful if the main control unit 200 inhibits disabling of the print setting used for the printing of the document by using the security setting.

The structure and content of the above-described various types of data are not limited to those described above. That is, the data according to the exemplary embodiments of the present invention can have various structures and contents within the scope and the purpose of use of the present invention.

The present invention can be implemented in a system, an apparatus, a method, a program, or a storage medium storing the program, for example. More specifically, the present invention can be applied to a system including a plurality of devices and to an apparatus that includes one device.

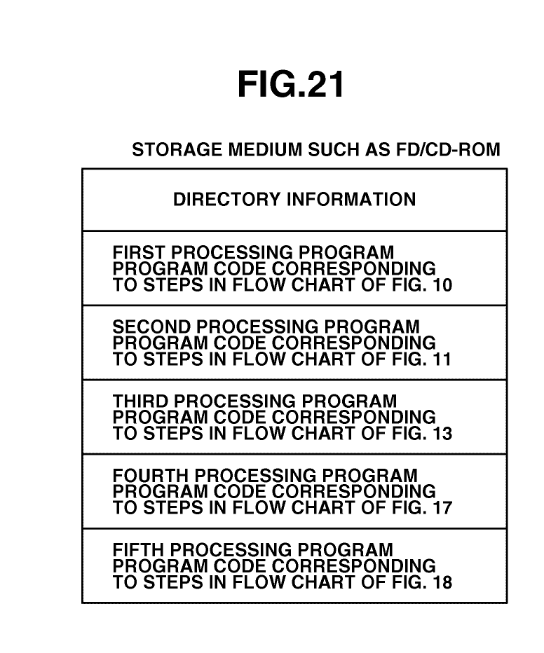

Hereinbelow, the configuration of a data processing program that can be read by a document management system including an information processing apparatus (a PC) according to an exemplary embodiment of the present invention is described with reference to a memory map illustrated in FIG. 21.

FIG. 21 illustrates a memory map of a computer-readable storage medium (recording medium) that stores (records) various programs that can cause a computer to function as the information processing apparatus (each server PC) constituting the document management system according to the exemplary embodiments of the present invention.

Although not illustrated in FIG. 21, information for managing the programs stored in the storage medium, such as version information and information concerning the creator of a program, for example, can be stored in the storage medium. In addition, information that depends on an OS of an apparatus that reads the program, such as an icon for identifying and displaying the program, can be stored in the storage medium.

In addition, data that is subordinate to the various programs is also managed in a directory of the storage medium. In addition, a program for installing the various programs on a computer can be stored in the storage medium. In addition, in the case where a program to be installed is compressed, a program for decompressing the compressed program can be stored in the storage medium.

In addition, the functions according to the above-described exemplary embodiments illustrated in FIGS. 10, 11, 13, 17, and 18 can be implemented by a host computer using a program that is externally installed. In this case, the present invention includes the case where a group of information including a program is supplied to an output device from a storage medium such as a compact disc-read only memory (CD-ROM), a flash memory, and an flexible disk (FD) or from an external storage medium via a network.

The present invention can also be achieved by providing a system or an apparatus with a storage medium storing program code of software implementing the functions of the embodiments and by reading and executing the program code stored in the storage medium with a computer of the system or the apparatus (a CPU or a micro processing unit (MPU)).

In this case, the program code itself, which is read from the storage medium, implements the functions of the embodiments described above, and accordingly, the storage medium storing the program code constitutes the present invention.

Accordingly, the program can be configured in any form, such as object code, a program executed by an interpreter, and script data supplied to an OS.

As the storage medium for supplying such program code, a floppy disk, a hard disk, an optical disk, a magneto-optical disk, a magnetooptic disk (MO), a CD-ROM, a compact disc recordable (CD-R), a compact disc rewritable (CD-RW), a magnetic tape, a nonvolatile memory card, a ROM, and a digital versatile disc (DVD (DVD-recordable (DVD-R), DVD-rewritable (DVD-RW))), for example, can be used.

In this case, the program code itself, which is read from the storage medium, implements the function of the embodiments mentioned above, and accordingly, the storage medium storing the program code constitutes the present invention.

The above described program can also be supplied by connecting to a web site on the Internet by using a browser of a client computer and by downloading the program from the web site to a storage medium such as a hard disk. In addition, the above program can also be supplied by downloading a compressed file that includes an automatic installation function from the web site to a storage medium such as a hard disk. The functions of the above embodiments can also be implemented by dividing the program code into a plurality of files and downloading each divided file from different web sites. That is, a World Wide Web (WWW) server and a file transfer protocol (ftp) server for allowing a plurality of users to download the program file for implementing the functional processing configure the present invention.

In addition, the above program can also be supplied by distributing a storage medium such as a CD-ROM and the like which stores the program according to the present invention after an encryption thereof; by allowing the user who is qualified for a prescribed condition to download key information for decoding the encryption from the web site via the Internet; and by executing and installing in the computer the encrypted program code by using the key information.

In addition, the functions according to the embodiments described above can be implemented not only by executing the program code read by the computer, but also implemented by the processing in which an OS or the like carries out a part of or the whole of the actual processing based on an instruction given by the program code.

Further, in another aspect of the embodiment of the present invention, after the program code read from the storage medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

In addition, the present invention can be applied to a system including a plurality of devices and to an apparatus that includes one device. Furthermore, the present invention can be implemented by supplying a system or an apparatus with a program. In this case, by reading the storage medium that stores a program described by software that can implement the present invention with the system or the apparatus, the system or the apparatus can implement the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-151751 filed Jun. 10, 2008, which is hereby incorporated by reference herein in its entirety.

What is claimed is:

1. A document management system configured to execute operations including managing document information, generating display data for displaying a content of the document information, and printing the document information according to an instruction issued by a user via a web browser of a client apparatus configured to execute display according to the generated display data, the document management system comprising:
a user attribute storage unit configured to store a user attribute of the user;
a first history storage unit configured, when the document information managed in the document management system is printed, to store identification information for identifying the document information and print setting information used in printing the document information in association with each other;
a second history storage unit configured, when the document information managed in the document management system is printed, to store the print setting information used in printing the document information and the user attribute of the user who has instructed the printing of the document information with the print setting information in association with each other;
a user attribute comparison unit configured, when the user issues an instruction for printing the document information via the web browser of the client apparatus, to identify the print setting information stored on the first history storage unit in association with the identification information for identifying the document information whose printing has been instructed, identify the user attribute stored on the second history storage unit in association with the identified print setting information, and compare the identified user attribute with the user attribute of the user who has instructed the printing of the document information, which is stored in the user attribute storage unit; and
a determination unit configured to determine print setting information to be used in printing the document information whose printing has been instructed by the user from among the print setting information stored on the second history storage unit according to a result of the comparison by the user attribute comparison unit.

2. The document management system according to claim 1, wherein
the user attribute comparison unit is configured, if a ratio of the user attribute of the user who has instructed the printing of the document information to user attributes stored on the second history storage unit in association with the print setting information exceeds a predetermined threshold value, to determine that the print setting information is correlated with the user attribute of the user who has instructed the printing of the document information as a comparison result, and
wherein the determination unit is configured to determine the print setting information that has been determined by the user attribute comparison unit to be correlated with the user attribute of the user who has instructed the printing of the document information as print setting information to be used in the printing.

3. The document management system according to claim 2, wherein the determination unit is configured to determine print setting information that has been most frequently used, among print setting information determined by the user attribute comparison unit to be correlated with the user attribute of the user who has instructed the printing of the document information, as print setting information to be used in the printing.

4. The document management system according to claim 1, further comprising:
a third history storage unit configured, when the document information managed in the document management system is printed, to store the print setting information used in printing the document information and a document attribute of the document information, which are associated with each other; and
a document attribute comparison unit configured, when the user issues an instruction for printing the document information via the web browser of the client apparatus, to identify the print setting information stored on the first history storage unit in association with the identification information for identifying the document information whose printing has been instructed, identify the document attribute stored on the third history storage unit in association with the identified print setting information, and compare the identified document attribute with the document attribute of the document information whose printing has been instructed by the user, wherein
the determination unit is configured to determine print setting information to be used in printing the document information whose printing has been instructed by the user based on the print setting information stored on the second or the third history storage unit according to a result of the comparison by the user attribute comparison unit or the document attribute comparison unit.

5. The document management system according to claim 4, wherein
the document attribute comparison unit is configured, if a ratio of the document attribute of the document information whose printing has been instructed by the user to document attributes stored on the third history storage unit in association with the print setting information exceeds a predetermined threshold value, to determine that the print setting information is correlated with the document attribute of the document information whose printing has been instructed by the user as a comparison result, and
wherein the determination unit is configured to determine the print setting information that has been determined by the document attribute comparison unit to be correlated with the document attribute of the document information whose printing has been instructed by the user as print setting information to be used in the printing.

6. The document management system according to claim 5, wherein
the document attribute includes a plurality of categories,
wherein in determining a degree of the correlation between the print setting information and the document information whose printing has been instructed by the user, the degree of correlation between the print setting information and the document information whose printing has been instructed by the user determined by the document attribute comparison unit becomes higher as a number of categories of the document attribute determined to be correlated with the print setting information increases as a result of the comparison, and
wherein the determination unit is configured, in determining the print setting information to be used for printing the document information whose printing has been instructed by the user according to the result of the comparison by the document attribute comparison unit, to determine the print setting information whose degree of correlation with the document information that the user has instructed the printing thereof is determined by the document attribute comparison unit to be high as the print setting information to be used in printing the document information.

7. The document management system according to claim 1, further comprising a print setting information presenting unit configured to execute control for editably presenting the print setting information determined by the determination unit on the client apparatus on which the user has instructed the printing.

8. The document management system according to claim 7, wherein the print setting information presenting unit is configured to execute control for presenting a setting related to security of the print setting information in a display state in which the user cannot disable the setting.

9. The document management system according to claim 8, wherein the setting related to the security of the print setting information includes a setting of a function for printing a copy-forgery-inhibited pattern.

10. The document management system according to claim 1, further comprising:
a fourth history storage unit configured, when the document information managed in the document management system is printed, to store a printing apparatus that has printed the document information and the user attribute of the user who has instructed the printing in association with each other;
a login user attribute comparison unit configured, when the user has logged into the document management system from the client apparatus, to compare the user attribute of the login user stored on the user attribute storage unit with the user attribute stored on the fourth history storage unit; and
a printing apparatus presenting unit configured to execute control for presenting information about a printing apparatus to be used by the login user on the client apparatus, which is selected from the printing apparatuses stored on the fourth history storage unit, according to a result of the comparison by the login user attribute comparison unit.

11. The document management system according to claim 10, wherein
the login user attribute comparison unit is configured, if a ratio of the user attribute of the login user to the user attributes stored on the fourth history storage unit in association with the printing apparatus exceeds a predetermined threshold value, to determine that the printing apparatus is correlated with the user attribute of the login user as a comparison result, and
wherein the printing apparatus presenting unit is configured to execute control for presenting information about the printing apparatus determined by the login user attribute comparison unit to be correlated with the user attribute of the login user.

12. The document management system according to claim 11, wherein
the user attribute includes a plurality of categories,
wherein in determining a degree of the correlation between the printing apparatus and the user attribute of the login user, the login user attribute comparison unit determines that the degree of correlation between the printing apparatus and the user attribute of the login user is higher as a number of categories of the user attribute determined to be correlated with the printing apparatus increases as a result of the comparison, and
wherein the printing apparatus presenting unit is configured to execute control for presenting information about a printing apparatus whose degree of correlation with the user attribute of the login user has been determined by the login user attribute comparison unit to be higher.

13. An information processing method in a document management system configured to execute operations including managing document information, generating display data for displaying a content of the document information, and printing the document information according to an instruction issued by a user via a web browser of a client apparatus configured to execute display according to the generated display data, the method comprising:
storing a user attribute of the user;
storing, when the document information managed in the document management system is printed, identification information for identifying the document information and print setting information used in printing the document information in association with each other;
storing, when the document information managed in the document management system is printed, the print setting information used in printing the document information and the user attribute of the user who has instructed the printing of the document information with the print setting information in association with each other;
identifying, according to an instruction issued by the user for printing the document information via the web browser of the client apparatus, the print setting information stored in association with the identification information for identifying the document information whose printing has been instructed;
identifying the user attribute stored in association with the identified print setting information;
comparing the identified user attribute with the stored user attribute of the user who has instructed the printing of the document information; and
determining print setting information to be used in printing the document information whose printing has been instructed by the user from among the stored print setting information according to a result of the comparison.

14. The method according to claim 13, further comprising:
determining, if a ratio of the user attribute of the user who has instructed the printing of the document information to the user attributes stored in association with the print setting information exceeds a predetermined threshold value, that the print setting information is correlated with the user attribute of the user who has instructed the printing of the document information; and
determining the print setting information that has been determined to be correlated with the user attribute of the user who has instructed the printing of the document information as print setting information to be used for the printing.

15. The method according to claim 13, further comprising:
storing, when the document information managed in the document management system is printed, the print setting information used in printing the document information and a document attribute of the document information in association with each other;
identifying, according to an instruction issued by the user for printing the document information via the web browser of the client apparatus, the print setting information stored in association with the identification information for identifying the document information whose printing has been instructed;
identifying the document attribute stored in association with the identified print setting information;
comparing the identified document attribute with the document attribute of the document information whose printing has been instructed by the user; and
determining print setting information to be used in printing the document information whose printing has been instructed by the user based on the stored print setting information according to a result of the user attribute comparison or the document attribute comparison.

16. The method according to claim 13, further comprising editably presenting the determined print setting information on the client apparatus on which the user has instructed the printing.

17. The method according to claim 16, further comprising presenting a setting related to security of the print setting information in a display state in which the user cannot disable the setting.

18. The method according to claim 13, further comprising:
storing, when the document information managed in the document management system is printed, a printing apparatus that has printed the document information and the user attribute of the user who has instructed the printing in association with each other;
comparing, according to login of the user into the document management system from the client apparatus, the stored user attribute of the login user with the stored user attribute of the user who has instructed the printing; and
presenting information about a printing apparatus to be used by the login user on the client apparatus, which is selected from the stored information about the printing apparatus, according to a result of the comparison of the login user attribute.

19. A computer-readable storage medium storing a program configured to implement the document management system according to claim 1.

20. A document management system configured to execute operations including managing document information, generating display data for displaying a content of the document information, and printing the document information according to an instruction issued by a user via a web browser of a client apparatus configured to execute display according to the generated display data, the document management system comprising:
a user attribute storage unit configured to store a user attribute of the user;
a history storage unit configured, when the document information managed in the document management system is printed, to store identification information for identifying the document information, print setting information used in printing the document information, and a user attribute of the user who has instructed the printing with the print setting information in association with each other;
a determination unit configured, according to the user instruction for printing the document information issued via the web browser of the client apparatus, to determine print setting information to be used in printing the document information whose printing has been instructed by the user from among the print setting information stored on the history storage unit in association with a part of the identification information of the document information whose printing has been instructed by the user and the user attribute of the user who has instructed the printing of the document information; and
a print setting information presenting unit configured to execute control for editably presenting the print setting information determined by the determination unit on the client apparatus on which the user has instructed the instruction for printing the document information, wherein
the print setting information presenting unit is configured to execute control for presenting the print setting information determined by the determination unit in a state in which the user cannot disable a setting related to security of the print setting information.

21. A computer-readable storage medium storing a program configured to implement the document management system according to claim 20.
